(19) United States
(12) Patent Application Publication
(10) Pub. No.: US 2010/0287146 A1
(43) Pub. Date: Nov. 11, 2010

(54) SYSTEM AND METHOD FOR CHANGE ANALYTICS BASED FORECAST AND QUERY OPTIMIZATION AND IMPACT IDENTIFICATION IN A VARIANCE-BASED FORECASTING SYSTEM WITH VISUALIZATION

(76) Inventors: Dean Skelton, San Ramon, CA (US); David Petiot, Calgary (CA); Southard P. Jones, San Francisco, CA (US)

Correspondence Address: PERKINS COIE LLP, P.O. BOX 1208, SEATTLE, WA, 98111-1208, US

(21) Appl. No.: 12/777,020

(22) Filed: May 10, 2010

Related U.S. Application Data
(60) Provisional application No. 61/177,016, filed on May 11, 2009.

(51) Int. Cl. G06F 17/30

(52) U.S. Cl. 707/705; 707/803; 707/E17.044; 707/E17.005; 707/802

(57) ABSTRACT

System, method, and computer program and computer program product for change analytics based forecast and query optimization and impact identification in a variance-based forecasting system with visualization. Server side system and method and client side customer system and method and interface. Variance engine and processor and processing method. Systems and methods for generating, displaying, and interacting with future event forecasts, and more particularly to systems, methods, computer programs, and applications for a delta, change, or variance based forecast interaction and visualization with event impact assessment and method for query optimization and impact identification in a variance based forecasting system and method.

### CROSS-REFERENCE TO RELATED APPLICATIONS

This application claims the benefit of priority to U.S. Provisional Application Ser. No. 61/177,016 filed 11 May 2009, which application, including the Appendix included therewith, is incorporated by reference herein in its entirety.

### FIELD OF INVENTION

This invention pertains generally to systems and methods for generating, displaying, and interacting with future event forecasts, and more particularly to systems, methods, computer programs, and applications for a delta, change, or variance based forecast interaction and visualization with event impact assessment and method for query optimization and impact identification in a variance based forecasting system and method.

BACKGROUND

In the process of forecasting (such as for example, forecasting sales or revenues or other event outcomes), processes and organizations typically capture the forecast in raw numbers input or otherwise provided from various people inside the different involved organizations. This process is typically completed on a periodic basis. In some instances the process may be completed once per quarter, or once per month, or once per week, but the frequency of such forecasts may usually be limited by the substantial work and pain involved in gathering the information and then in making the forecast. One major pain point for the people who review the forecast in an attempt to understand trends and patterns in the forecast, is to understand how the current forecast differs from the previous forecast or even from more than one forecast. In other words, when two (or more) forecasts, differ, why do they differ, and can some corrective action be taken.

In most organizations, human data analysts take or otherwise acquire snapshots of each forecast and go through the manual and labor intensive process of comparing the two snapshots to try to find out what has changed. Computers may be used in combination with the manual effort but the manual effort has conventionally been required. Determining what has changed may be only a first step and will only be a precursor to perhaps the even more difficult tasks of determining why these changes occurred and can any corrective action be taken if the trend in the forecast is negative (such as declining sales) or positive (can we identify the reason for increases and take advantage of its underlying reasons). Some organizations may have a business intelligence tool that enables them to more quickly and in automated fashion compare the two forecast snapshots. However, heretofore there are problems and/or limitations with both conventional approaches and with the tools used for these conventional approaches.

The manual approach is time consuming, error-prone, and one person or analyst or even a small group of human analysts can only handle so much data. Having multiple persons performing this task is possible but then distribution of subtasks and coordination may be problematic. If they are using Excel or another spreadsheet application, they also run into data and functional constraints that prevent them from determining exactly what has changed. They also struggle to ‘roll-up’ these changes in a hierarchical fashion so that executives or other decision makers can understand the thousands of changes at a simple aggregate level.

The more automated business intelligence approach can resolve some of the issues around manual error-prone data aggregation and compiling—as well as data volume issues. However, even a conventional automated business intelligence (BI) based snapshot approach is limited in that they only can see and show the end-points of the forecast snapshots—they have not heretofore permitted viewing the path of how the forecast has changed. Therefore the frequency, periodicity, or the time between snapshots determines the granularity of change analysis. Secondly, the more snapshots one takes, the larger the data volumes grow, and conventional business intelligence application run into some data volume issues. Thirdly, the business intelligence application, typically struggles to pinpoint the top impact of the changes, because it is focused on the specific change in the forecast, instead of the impact of those changes. It does not have context of the change, so it can only show the difference between forecasts, such as difference between forecasts for company A at time point 1 to forecast for company A at time point 2. Finally, business intelligence (BI) tools conventionally fail to provide a view of the data that enables executives and managers to understand quickly—exactly what has changed between any points—at an aggregate level as well as detailed level.

There is therefore a need for a solution that overcomes these and other problems and limitations.

### SUMMARY

System, method, and computer program and computer program product for change analytics based forecast and query optimization and impact identification in a variance-based forecasting system with visualization. Variance engine and processor and processing method.

Systems and methods for generating, displaying, and interacting with future event forecasts, and more particularly to systems, methods, computer programs, and applications for a delta, change, or variance based forecast interaction and visualization with event impact assessment and method for query optimization and impact identification in a variance based forecasting system and method.

A system for generating a variance based forecast, the system including: (a) multi-dimensional mode processing engine; (b) a relational database and database structure defined therein for storing forecast updates and metadata that describes dimensions and other configuration information coupled to the processing engine; (c) a data access layer server for processing requests to both the multi-dimensional mode processing engine and to the relational database system; and (d) a handler that exposes services for retrieving data from and, in the case of the relational database system, inserting data into the database; (e) wherein the database stores future event forecast variance data including forecast data pertaining to dates, as-of-when (AOW), and as-of-now (AON) parameters.

A computer implemented method and computer program product for generating a variance based forecast, the method including the steps: (a) operating a multi-dimensional mode processing engine; (b) establishing a relational database and database structure defined therein for storing forecast updates and metadata that describes dimensions and other configuration information coupled to the processing engine; (c) processing requests at a data access layer server to both the multi-dimensional mode processing engine and to the relational database system; and (d) exposing services for retrieving data from and, in the case of the relational database system, inserting data into the database; (e) wherein the database stores future event forecast variance data including forecast data pertaining to dates, as-of-when (AOW), and as-of-now (AON) parameters.

A variance engine including: a variance processor configured for processing data elements accessed from an external database defining a data structure and organized according to: (i) dimensions and hierarchies that categorize forecast data for highly granular variance analysis, and (ii) forecast information including time based forecast information defined by an as-of-when (AOW) value parameter and an as-of-now (AON) value parameter; the AON and AOW parameter values being stored and maintained separately for efficient retrieval from the database system; and the variance processor generating a forecast variance as a difference between a new AON and a last AOW forecast value parameters.

A computer implemented method for operating a variance engine the method including: processing data elements accessed from an external database defining a data structure and organized according to: (i) dimensions and hierarchies that categorize forecast data for highly granular variance analysis, and (ii) forecast information including time based forecast information defined by an as-of-when (AOW) value parameter and an as-of-now (AON) value parameter; storing and maintaining the AON and AOW parameter values separately for efficient retrieval from the database system; and generating a forecast variance as a difference between a new AON and a last AOW forecast value parameters.

### BRIEF DESCRIPTION OF THE DRAWINGS

FIG. 1 is an illustration showing an example for a graphical trend chart or dashboard display for a specific company forecast over a 1 year period of time according to an example of the invention.

FIG. 2 is an illustration showing example hierarchical relationships between a Business Unit at a top level, a Product Family at an intermediate level, and a Product or Produce SKU at a lower level.

FIG. 3 is an illustration showing forecast data and relationships with associated data as a function of time.

FIG. 4 is an illustration showing a chart that may be selected to augment the forecast data display in FIG. 1 to add a pie chart that shows the relative and absolute contributions and relative contributions to forecast changes.

FIG. 5 is an illustration showing one of the basic notions of how changes are organized in the system at a object level.

FIG. 6 is an illustration showing a portion of a forecast trend line with selected starting and end point markers.

FIG. 7 is an illustration showing an example of a user transaction inspector interface and display that provides a graphical display similar to that shown in the example of FIG. 1 but showing multiple forecasts.

FIG. 8 is an illustration showing a display screen and graphical user interface of how a user or analyst would select this multiple categories comparison feature tool.

FIG. 9 is an illustration showing an example Change Summary showing the top positive and top negative contributions in the forecast trend.

FIG. 10 is an illustration showing an alternate view of a forecast trend and provides detailed changes in an additional pull out table, including showing the last 100 changes that were made for the particular forecast that is being analyzed.

FIG. 11 is an illustration showing an example screen display or dashboard view showing the manner in which sales forecasts have evolved over time, display portions that assist in understanding the volatility of sales forecasts such as the number of forecast changes per day, and a window that permits selection of a time range on which to focus analysis.

FIG. 12 is an illustration showing an example screen display or dashboard view highlighting a portion of the display with high and low points of the forecast for a selected time range, a display window for obtaining insight into top and bottom product, customer, and region changes that are driving the forecast in the selected time range; and a window for analyzing detailed forecast changes for the selected time range.

FIG. 13 is an illustration showing an example screen display or dashboard view with a portion of the display for drilling on a specific product and for seeing the impact of prince and/or quantity changes on the sales forecast for that selected time range; and a second portion for understanding the detailed sales forecast changes for the selected product and time range.

FIG. 14 is an illustration showing and block diagram of a system that may be used to implement aspects of the invention.

FIG. 15 is an illustration showing features and aspects of an example data structure and database including Dimension, Member, Forecast Stream, Forecast Element, Forecast Stream Data Measure, Composite Stream Data, Dynamic Delta View and their relationships to each other and as they contribute to generating and presenting a view.

FIG. 16 is an illustration showing portions of the data structure and database elements and relationships as in FIG. 15.

FIG. 17 is an illustration showing configurability features.

FIG. 18 is an illustration showing tracking of different forecasts and the various forecast representations that may be used and configured.

FIG. 19 is an illustration showing aspects of multi-level forecast according to examples of the invention.

FIG. 20 is an illustration showing aspects of the process by which data travels into the system and is processed according to the innovative methods and procedures, and that is manifested into the constituent components for the change or variance based analysis.

FIG. 21 is an illustration showing aspects of an embodiment of a variance engine.

### DETAILED DESCRIPTION

In one aspect, the inventive system, method, and computer software program provides an application and application environment that shows how a forecast has evolved over time. It permits and provides a graphical display (or dashboard) of the path of the forecast changes, facilitated by actually storing the change(s) along with contextual information about the change(s), so it can show not only the end points of the forecast evolution, but also the path of the forecast evolution. It also advantageously, shows and permits analysis of the business reason(s) for why the forecast has changed.

It will be appreciated in light of the description provided here that the method, application, and computer program may be implemented in a computer or computer system having at least one processor or processing logic and memory coupled to the processor or processing logic for storing the computer program software or firmware code and data and intermediate results of such processor computations. The computer program code includes executable instructions for performing the processes and methods describe herein. A mass storage device such as one or more hard disc drives may be provided for storing code and data, including for defining and storing a database and data structure for the forecast data described herein after.

Understanding why a forecast has changed, such as a decline in sales in sales forecast, or a change (increase or decrease) in another event forecast or outcome, advantageously permits some action to alter the conditions that are leading to the decline in sales or other forecast change. Therefore the application permits and provides for proactive action and is not merely an application that looks at past events.

To put this in some context, traditionally forecast data is stored in snapshot form. Typically, snapshot form is a method or system whereby numbers or other information are summarized for a given time unit like a day, a month or a quarter. All data is summarized for the period and that data is typically kept separate from other time unit snapshots. This results in two things, a lot of incremental data above and beyond the changes being stored as well as limited flexibility in that time granularity is limited to the predefined unit of time. In a multi-customer system, this is exasperated by the fact that each customer may have a different notion of what that cadence should be. If a customer decides to change the granularity and further requires that it be retroactively reflected in the system, the problem of accommodating that is of a large magnitude, if not impossible altogether.

These conventional snapshots may typically be taken monthly and it is virtually or practically impossible to achieve weekly or daily granularity of the forecast data or underlying forecast information. At the very least, it is too time consuming and labor intensive from a business standpoint to take them at increased frequency. Even if the burden of capturing or generating these snapshots more frequently, could be tolerated, they would conventionally be limited to some pre-scheduled dates or intervals, and would not permit a dynamically generated forecast that was under the control and timing of the user or analyst so as to provide forecasting that was dynamic, and met the needs of the forecaster, whether for business, financial, economic, scientific, or other purposes or applications. What this means is an individual could do monthly (or even weekly or more frequent) conventional comparisons of the forecast data (usually in cumbersome spreadsheets) but they would lose any time granularity of that forecast data and as a result, a lot of the details as to why there was change between the two forecasts or forecast end points.

The innovative forecasts may also be generated in real-time or substantially real-time so that there is little delay in providing, selecting, or accessing any required data or information and generating the forecast or other report. Real-time or substantially-real time means that the forecast or report may be generated with very little delay, such as from less than a second, to several seconds, or minutes. Usually the generated forecast or report would be available while the analyst is working from a computer and any lag or delay would not represent a break in the work, so that the report would be available within less than a minute to several minutes. Real-time or substantially real time may not be required for all embodiments so that an analyst may for convenience choose to initiate a forecast or report or set of forecasts or reports and access the results at a later time, however, the real-time or substantially real-time capabilities provide greater convenience and utility.

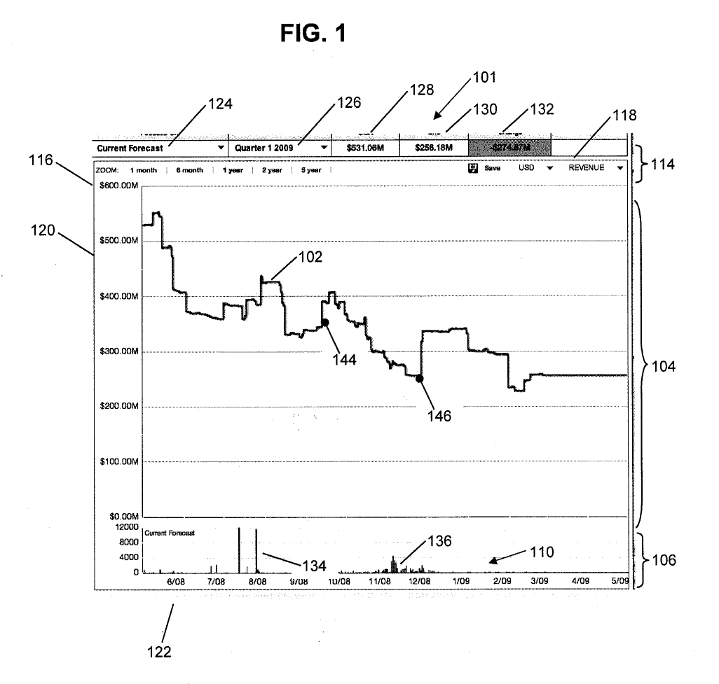

The inventive application, system, and method is able to maintain lossless comparisons on any periodic or aperiodic basis, typically daily (and hourly or according to other predetermined or dynamically determined policies if warranted) of forecast data and in addition, can show the user or analyst the detailed transactions that make up the changes so that users, analysts, or decision makers can understand what is going on in their forecast on a real-time or substantially real-time basis. In other words, the real time or substantially real-time basis means that once changes and the reasons for the changes are understood, action may be taken to alter course of action, policies, prices, promotions, or other activities in an attempt to move forecasts (and as a consequence actual event outcomes that are forecast) in a desired direction to toward a desired goal or outcome. For example, if sales forecasts for a particular product or service have declined, then the reason for the forecast decline may be identified, and corrective action, such as an adjusted sales price or more intensive promotion of that product may be initiated to move the forecast toward greater sales. This allows for faster response to changes in the business or other outcomes in a technical or non-business situations. For example, a technical situation may be the forecast for the completion of a new engineered product, the reduction in an environmental pollutant discharge, or other event that is susceptible to forecast and tracking. These capabilities enable the inventive system, method, and application to generate information, including forecast information, and produce readily understandable and interactive on-screen displays such as that illustrated in FIG. 1.

FIG. 1 illustrates an example of a displayed chart 101 for a specific company forecast trended over a 1 year period of time from June 2008 (6/08) through May 2009 (5/09) with trend line 102. There is an upper chart portion 104 showing the trend line 102 and a lower chart portion 106 to the display 108 and to the underlying data or information 110 such as the current forecast data 112 from which the trend line display is generated. There is also a forecast portion with text information 114 above upper chart portion 104. In this particular display presentation of the input data or current forecast and the trend line generated, the presentation shows a 1-year but the zoom buttons 116 bay be used to zoom in on or selected different periods, such as 1 month, 6 months, 1 year, 2 years, 5 years, or any other period of time. Sliders may also or alternatively be used to provide a continuous zoom range and windows may be used to select particular ranges as well. Pull-down tabs 118 are provide for selecting additional and/or alternate data and/or display formats or parameters.

The inventive application, system, and method provide a novel and unique way to analyze, generate a data structure storing the forecast information and forecast evolution as a function of time or events, and display the forecast and forecast evolution, showing the value of the forecast as of any point in time. Advantageously, this forecast information and analysis may be provided in real-time or substantially real-time with fine time granularity. Time granularity conceptually governs the level of detail preserved in the system's and method's notion of time. Typically, conventional snapshot based systems and methods will pre-define the level of detail to a predictable cadence, time interval, or schedule since the act of generating and storing a conventional snapshot is expensive. This limits the conventional system and method in at least one major way. If a customer requires a level of granularity beyond that snapshot, the information or data is simply not available and the desired forecast cannot be generated. Then, creating it requires redefining the snapshot detail and then generating and storing the new snapshot. If the customer (either directly or though a user or analyst (also referred to here as a forecaster) wants this to be retroactive to past data, then the task is amplified, if not rendered completely impossible. Not only that, but in a multi-customer environment (as compared to a single-customer environment), each customer will have their own notion of what that snapshot interval or level of detail or time and data granularity should be. All of this, indicates that a system and method as provided by the here described innovative technology has the flexibility in defining the level of detail and time and data granularity to overcome the conventional system and method limitations and disadvantages. In fact, this flexibility is non-finite. A user must be able to, in some cases, ask for the forecast data on a specific day, at a specific time, and perhaps even a specific second, depending on real-world circumstances and requirements and the forecasting environment. This may for example, include changes in a rapidly changing business environment where decisions must me made dynamically and in real-time with changes in the business circumstances and/or opportunities, market forces and conditions, or evolutions of a technology problem, for example. Conventional snapshot based methods or any other conventional methods that rely on predefined notions of what that level of detail should be, are inadequate to solve such forecasting requirements in spite of the fact that they are expensive to run and extremely difficult to change. The inventive technology including the system, computer implemented method, and any computer program code and its executable instructions and data are both more flexible, less expensive, and more responsive to such modern forecasting needs and requirements.

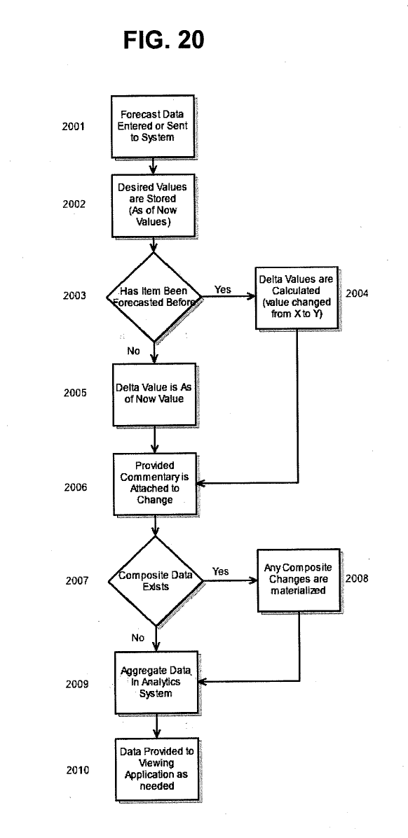

These advantages are achieved and operate with high performance across multiple forecasts at least in part because of an inventive modeling scheme that uses an underlying novel database design and database structure including the use of changes and variance. Further details of this scheme are describe herein after with reference to the other figures and FIG. 20 in particular, illustrates and describes aspects of the process by which data travels into the system and is processed according to the innovative methods and procedures, and that is manifested into the constituent components for the change or variance based analysis.

With further reference to the chart 101 of FIG. 1 the chart 101 in the upper portion is a two-dimensional graphical plot of financial forecast (such as sales or revenue) 120 here from $0.00M to $600.00M, versus date 122, here June 2008 through May 2009. The display also provides an indication of the type of display (e.g. Current Forecast) 124, the financial or applicable calendar period (e.g. Quarter 1 2009) 126, the forecast at the beginning of the selected period in June 2008 of $531.06 Million 128, the forecast at the end of the selected period in May 2009 of $256.18M 130, and the (highlighted) change 132 (−$274.87 Million) in the forecast. A zoom capability 116 (such as 1-month, 6-month, 1-year, 2-year, or 5-year time periods) permits the user to zoom or magnify/demagnify parts of the display or dashboard to see greater time or data, granularity or lesser time or data granularity but larger context of the data. Interactive buttons, roll-over hot spots, and pull-down menus are or may be provided to facilitate analyst or user interaction with the data shown and/or underlying the displayed charts and other information.

The chart 101 in the lower potion of the display or lower chart 106 in this image also displays volume information for the forecast, such as in the form of a histogram where the height of the histogram at a particular date or date range shows how many changes are being made on any given day or other time period and a number on the vertical axis showing the volume of changes. Here one observes a high volume of changes 134 around August 2008 as well as lower number but more frequent changes in the November-December 2008 time period 136. In this non-limiting example, this volume data is illustrated as a kind of bar chart or histogram where the height of the bar is proportional to the volume, however, other forms of volume data display may be used, and the user may mouse click on the bar chart to have a numerical value and/or other information displayed. In this example, the time or data granularity of this information is daily; however, data granularity with respect to a time period at longer or shorter time intervals of time may be selected, though one of the advantages of the application is that granularity may be at frequent intervals, such as weekly or even more advantageously at daily (e.g., 24 hr) or hourly (ever hour or at selected hourly intervals, such as 2 hours, 4 hours, 6 hours, 8 hours, 12 hours, etc.) level of detail. The customer, user or analyst has an ability to choose the time and data granularity that he/she wished to perform the analysis and view the analysis results.

Additionally, in meeting the true business, scientific, or other process needs—a user can highlight any two points on the chart, such as any two points on the trend line 102, and thereby effectively select a data start and a data end range on which to focus their analysis. This may be a single day, or set of days, or any other time period that they wish to enquire further about. By doing this they can see specifically what changes in the underlying data or information caused the forecast to move from any two points. This can be done for various sets of data so that virtually any selection or combination of comparisons may easily be made. The user can see this forecast evolution path in various dimensions at various levels—and understand the changes in it by type of change. These dimensional features are described in greater detail herein elsewhere.

To explain a little deeper, forecasting involves categorizing information in a hierarchical structure know commonly as dimensions. Dimensions in a business sense may often take the form of a product hierarchy or customer grouping tree or geographic categorization but could also be represented by less common notions such as warehouse a warehouse hierarchy or selling channel structure. Dimensions in a more general scientific, engineering, project management, or other process sense may involve categorization appropriate to those applications or processes.

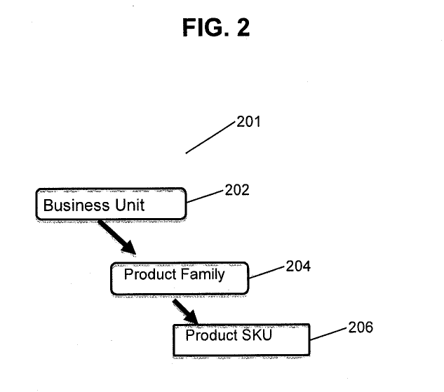

A common dimensional structure describing a product hierarchy is illustrated in FIG. 2 which-shows example hierarchical relationships 201 between a Business Unit 202 at a top level, a Product Family 204 at an intermediate level, and a Product or Produce SKU 206 at a lower level. Other applications or processes may also identify and use hierarchical relationships appropriate to their application or process.

Additionally, the forecast involves making or generating a numerical prediction or measurement or an indicator that may be mapped to a numerical predictor or measurement, such as a forecast that might involve a letter grade (e.g., A, B, C, D, or E) or a “pass” or “not pass” type of indicator. Returning to the business forecast involving a product, typically, though not always, this would involve predicting future quantity demand, pricing information, cost, or currency exchange rate, as non-limiting examples. It may also be the case that more abstract concepts are predicted such as probability or confidence. The invention is not limited to any particular forecasts, future events, or predictions, and the above are merely illustrative but valuable examples.

In many common scenarios these predictions are interwoven to produce meaningful business or non-business metrics or measurements in the forecast. For example, in the business context a revenue forecast is an unit forecast multiplied by a price forecast to equal a revenue forecast. When an currency exchange rate forecast is also included, the problem of tracking this revenue forecast is further amplified.

The system, method, application, and computer program described here provides an underlying database and analytical structure and method to provide these capabilities.

For example, the system and method records the changes for all of the user defined forecasts and measurements and performs the calculations to enable these business metrics in the forecast. To do this and present it back to the user so they can view the trend in this information over periods of time spanning multiple days, a storage and assembling strategy is implemented called Variance-based Forecast Composition.

One of the problems that was associated with conventional systems and methods was that the problem in trying to present trending data at frequent time and data granularity (such a daily granularity) and organized and categorized into multiple user defined hierarchies is that the data is all moving independently. A unit forecast may be fluctuating at a different time pace or cadence than price information, yet at any point in time one needs to assemble the current price and the current unit forecast for a given day to calculate current predicted revenue for that day. It must be noted that this is the simplest example and may not seem so complicated but when multiple factors or parameters can each change in this manner then the complexity is significantly increased.

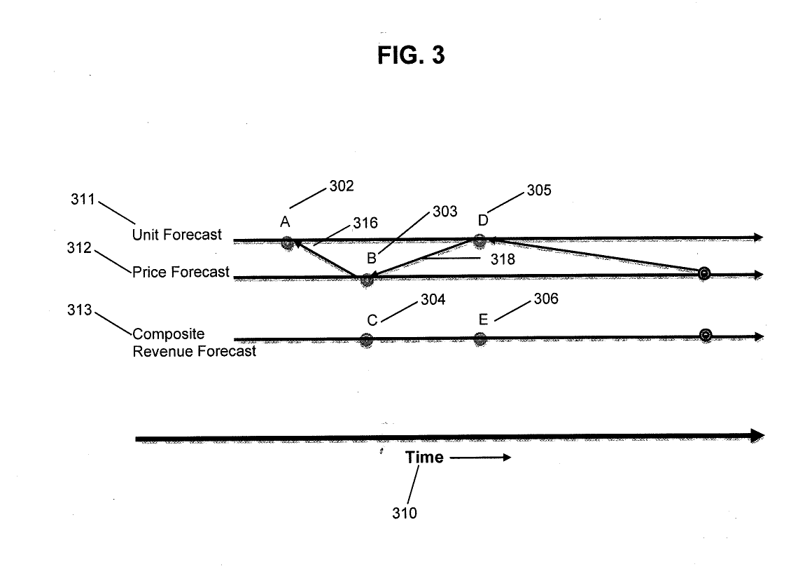

The inventive Variance-based Forecast Composition weaves each of these individual forecast streams together using pointers between the change records by way of time linearity and calculates and aggregates the values through the customer defined dimensional structures (like products or customers) using a multi-dimensional analytical system. A non-limiting example is now described relative to a very simple illustrative example in FIG. 3 which shows forecast data and relationships with associated data as a function of time.

In FIG. 3, there is illustrated a time line 310 on the horizontal axis, and parallel lines for Unit Forecast 311, Price Forecast 312, and composite revenue Forecast 312, along with a set of points. Point A 302 represents a unit or quantity forecast measurement for a given day, there is no associated revenue at this time since price has not been forecast. Essentially revenue is deemed as zero ($0.00) in this example. Point B 303 represents a price forecast and when created it maintains a first pointer 316 back to the last known quantity forecast at Point A. By doing this, revenue can be calculated for this day (same day as Point B) as represented by Point C 304. A further quantity adjustment is made at Point D 305 and a second pointer 318 is established back to Point B so that revenue can be determined on that day (same day as Point D) at Point E 306. This goes on and on for different or subsequent days or time intervals. Days are used here by way of example and other or different time periods or intervals may be used. One may observe that at each measurement point the system and method are tracking the variance information and this variance information then gets combined or aggregated upwards through the hierarchies that have been defined. In one non-limiting example, a multi-dimensional analysis engine and platform are used to accomplish this, such as for example, a multi-dimensional On-line Analytical Processing (OLAP) engine, OLAP Cube, other OLAP based analysis platform.

In one non-limiting example, tracking the variance information involves a process that includes the following process steps. First, forecast data is received from an external or internal source. Forecast data is comprised of a desired value for a given period of time. May come in collection form of multiple values or as a single value. Forecast data is targeted for a forecast container or plan (that is for a Current Forecast). Second, the process retrieves the most recent value for the forecasted item, and if a previous value does not exist then an initial or starting values is assumed such as a value of zero (“0”). Third, the process calculates the variance between the received value and the previous value. Fourth, a record is created and stored in the database that captures the variance as well as the net or forecasted value. Fifth, the processes updates the forecasted item's “As of Now” (AON) value to be the submitted forecast value.

It may be observed that in at least one non-limiting example, the variance information gets combined or aggregated upwards through the hierarchies that have been defined. The data is also advantageously organized into normal dimensions to index the change or variance data in such a way that a traditional analytics engine can provide query results effectively in aggregate.

This system and method are able to maintain all discrete changes to the forecast and is able to assemble them back to the user, optionally but advantageously filtered based either on dimensional considerations or for given periods of time or both, or according to other filters and filtering criteria.

Of particular significance and advantage is the notion of and use in the innovative system and method of the “as of when” (AOW) data and “as-of-now” (AON) data. In order to portray change or variance data over time it must be the case that the system and method have an intimate understand (such as for example may be provided by the system architecture, methodological steps, and process and computer code organization and structure) of the notion of as-of-when AOW. As of when data affords the capability of not only asking the system and method what was the value at a point in time in the past, but also how it evolved over time either by plotting it's course as such or comparing its value to another point in time. In order to do this effectively, the system and method should have a strong notion of change or variance and that notion should be correlated to time. As the forecast data changes, the system and method should track the relative change as well as the resulting end result of the change which is then deemed the (new) AON value. Because of this inventive storage and composition mechanism, the innovative system and method are able to maintain all discrete changes to the forecast and is able to assemble them back to the user, optionally but advantageously filtered based either on dimensional considerations or for given periods of time or both, or according to other filters and filtering criteria. The user may even optionally ask or query the system and method in a way that would be analogous to a natural language query expression: “Tell me all the changes that account for this drop in the forecast for CustomerX between Monday and Friday last week”. This provides a very simple and intuitive solution, for a query and analysis. Other interfaces may alternatively be used, such as a more conventional text or GUI interface. Advantageously, no matter what the actual interface, it is advantageous that the presentation scheme or logic guide a customer, user, or analyst through the process to arrive at a useful and accurate forecast, answer, or other query result. Optionally or additionally each change or group of changes may be created with additional reasoning information either in the form of qualitative commentary or more advantageously, in terms of user or analyst (e.g., customer) defined reasons which can be incorporated into the system and method.

One non-limiting example would be if a forecast updates a given prediction. Then a user or analyst could optionally but advantageously add commentary stating that their confidence level in the forecast number (or component of the forecast number) had fallen for some reason (for example input as free text) and/or could further or alternatively select a reason from a list of candidate reasons as well.

To further illustrate the example, a user or analyst such as a customer may have defined a reason or even any number of reasons for change around confidence, such as three reasons for change around confidence referred to as “Low Confidence”, “Medium Confidence” and “High Confidence”. Since this gets attached as an annotation to the discrete change record, the analytical capability can take this information and provide it back to the user and even aggregate the change reason in an analytical system in the same way a dimension is aggregated.

Every change made to the system is advantageously subsequently captured as an AON/AOW combination in the system. Each change is also optionally connected to a reason code that is defined by the users of the system and method. In the example case above we have a notion of quantifying confidence into a range of possibilities. Because of the granular notion of time related to these changes and the ability to organize data such that one can see what has changed over a finite period of time. The introduction of arbitrary notions of “reasons for change” is an introduction of additional dimensionality of the data making it possible to slice (or analyze) the changes that have been made by the new dimension. In the above example case, the confidence in the change, but this is merely one example and we should not limit to just this. Because this concept is introduced as a dimensional element, traditional analytics tools allow for the system to expose the this no concept of dimensionality for analysis as it relates to other notions of dimensionality like customers, products, etc.

Therefore, adding to the question presented earlier, a user or analyst could ask the system in a query: “Tell me all the changes that account for this drop in the forecast for CustomerX between Monday and Friday last week that are tagged as High Confidence”. This would give the user insight as to their own confidence in any given user's prediction, whether their own prediction or a prediction generated or initiated by another user or analyst. The analyst may also submit the query or make an annotation to the effect: If the forecast is going down, or continues to change in any way, why is the confidence level still high?

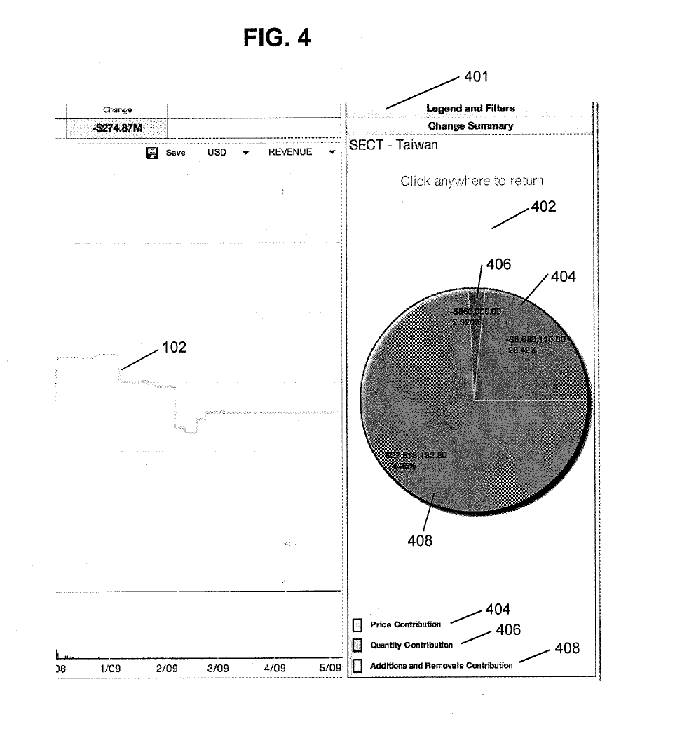

FIG. 4 provides an illustration of a chart that may be selected to augment the display in FIG. 1 that illustrated trend line 102 to add a pie chart (or other display) 402 that shows the relative and/or absolute contributions for the −$274,870,000.00 total change for Price Contribution 404 (here, −$8,860,118.00 or 23.42%), Quantity Contribution 406 (here, −$860,000.00 or 2.32%), and Additions and Removals Cqntribution 408 (here, +$27,523,132.80 or 74.25%) that is beneficial in understanding how the system and method is able to break down or analyze in more detail a portion of the forecast data into three reasons for change, a price change only, a quantity change, or the complete addition or removal of forecast information, as may be the case when a new customer or product is added to the forecast or an old one taken away.

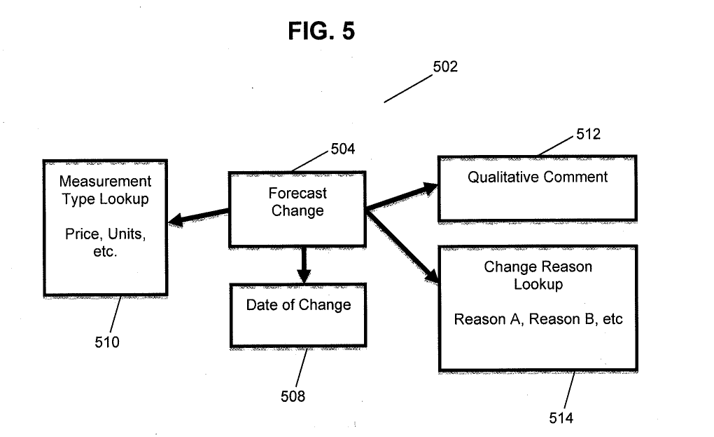

FIG. 5 illustrates one of the basic notions of how these forecast reasons or annotations are organized in the system at a data object level. For any Forecast Change 504, the database 506 is updated to store or write (and later to read or access) a Date of Change 508 of the Forecast Change 504, a Measurement Type Lookup 510 that may include Price, Units, or other type indicators or information, an optional but qualitative comment or remark 512, and a Change Reason Lookup 514 (that may include a plurality of reasons, such as Reason A and/or Reason B, etc.). These are referred to as lookups because a customer or user will define what measurements they wish to forecast and what reasons they wish to track as the forecast changes. While price and units are both common types of measurement, the inventive system and method are not limited to these only. It may be the case that the user or customer wishes to forecast other things such as for example, headcount or some other arbitrary thing. Reasons for the change are or may be treated in the same way through a lookup construct.

These custom and/or other somewhat arbitrary but defined forecasts may be included in the system, method, and application, and it may be appreciated in light of the description provided here, that so long as data pertaining to a forecast is provided as an input or may be computed from other data that has been input or is otherwise available, the forecast may be a forecast for this data or may take that data into account in making any other forecast or in analyzing the changes in a forecast.

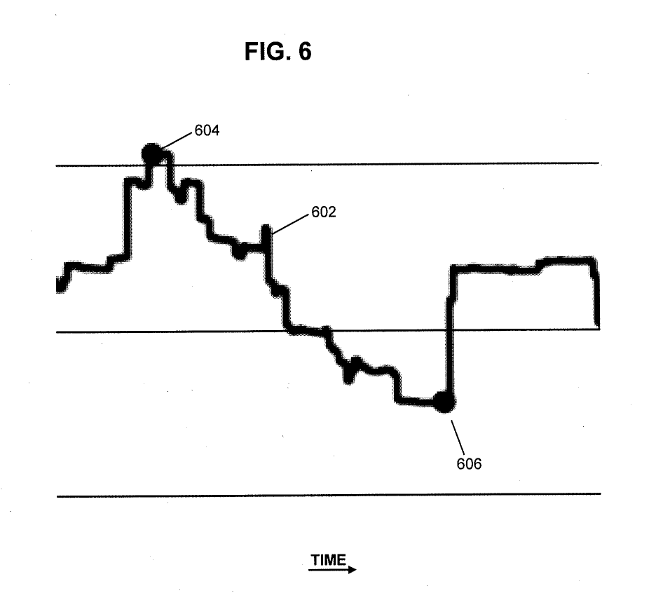

From a user or analyst experience perspective the method and application presents as a tool that allows a user to look at a forecast prediction trended out over a period of time at a level of detail that is relevant to the user or analyst needs and query objectives. This allows the user to see either subtle or massive changes in the forecast visually (according to their selected view and granularity) and then focusing in on that or any identified change so as be able to quickly understand why and how the change is occurring. For example, the user may see a drop in a given forecast as illustrated in the example forecast trend line 602 of FIG. 6 which is a 2-3 month portion (between about August 2008-October 2008 and December 2008) of a longer trend line 102 such as illustrated in FIG. 1.

Wanting to understand more, the user may decide to look at only the range highlighted by, the two markers or points 604, 606 of the trend line of FIG. 6 that correspond in this example to points 144, 146 of FIG. 1. It may be noted that this trend line 602 and the two identified points 604, 606 may actually be shown to the user or analyst in the form of the display in FIG. 1. By indicating this range of interest, the system and method will only bring back the relevant changes contributing to the time range (here the period between August-September 2008 and December 2008) specified by the user and thus the user can hone in on the factor and other drivers to this and understand the impact on the forecast. The user need not consider the other data and the system and method are unburdened from having to consider other data as well, thereby simplifying the computations and increasing timeliness.

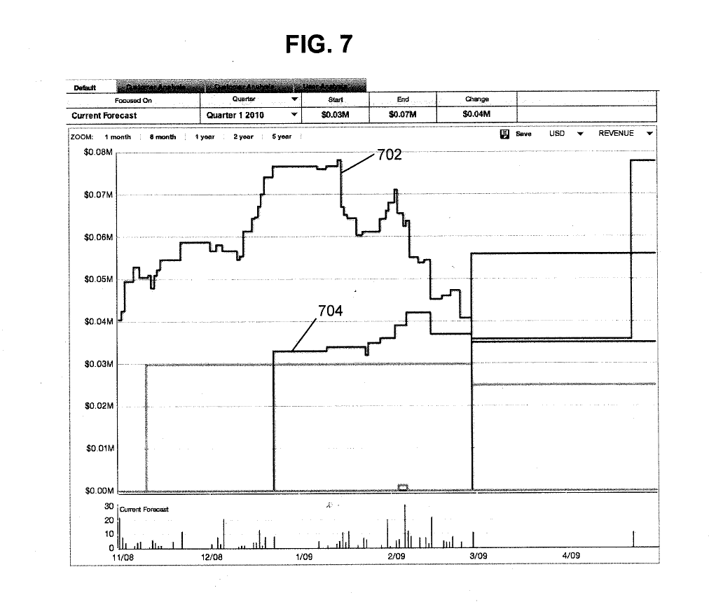

As has been described previously, no low level information is lost in the system or method. The detailed change transactions are always stored and available to the user. If one is looking at a particular slice or region of the forecast and wishes to inspect all the details of changes that have been created then the user may access and view this information. A functional tool referred to as a Transaction Inspector may be shown to the user and give the user access to these data and information records. An example of such a user Transaction Inspector interface is illustrated in FIG. 7.

The example transaction inspector interface in FIG. 7 provides a graphical display or dashboard view similar to that shown in the example of FIG. 1 and is supported by underlying tangible data structures but that one drawing (FIG. 7) shows multiple forecast plots or trend lines 702, 704 while the other drawing shows a single forecast plot (FIG. 1) or trend line 102.

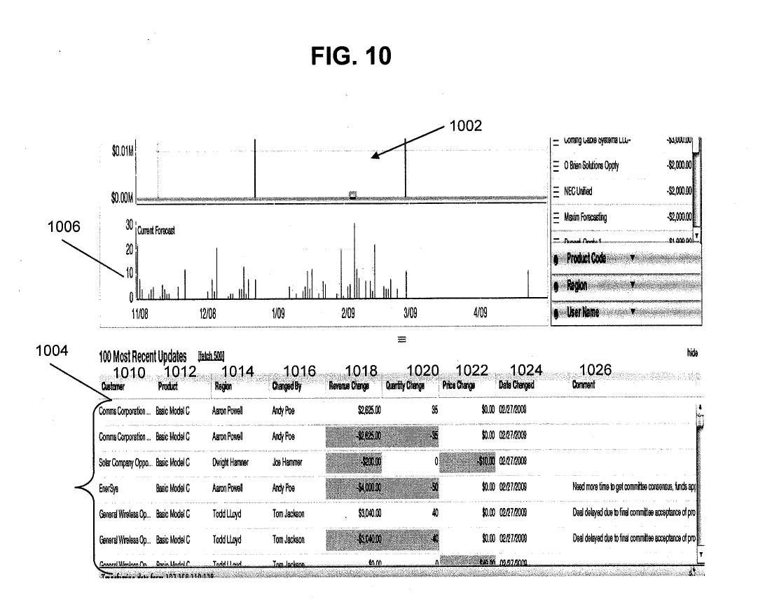

It may also be noted that FIG. 10 provides yet another alternate view and provides detailed changes in an additional pull out or pull down table, including showing the last 100 changes (or any other identified number of changes) that were made for the particular forecast that is being analyzed. FIG. 10 may be seen to be a portion of a chart like that in FIG. 1 where only the lower part of the chart is show and where one of the additional pull-down tabs, such as tab 118 in FIG. 1) has been selected. Additional records may selectively be chosen and viewed according to user commands. Each of these different displays is an example of the flexible and rich display capabilities of the inventive method and application provide by the system and method.

The inventive system, method, application, and computer program stored on a tangible machine readable media may advantageously include many features and tools that provide and facilitate the analytical, database, and graphical user interface interaction and generation and presentation of the data and processed information. These include by way of example but not of limitation, a Change Chart Feature Tool, Multiple Forecast Plans Comparison Feature Tool, Multiple Categories Comparison Feature Tool, Change Summary Feature Tool, Change Details Feature Tool 165, and any combinations of two or more of these, and these are now described in additional detail.

The Change Chart Feature Tool is a powerful visual feature with underlying system and method analytics engine and database support that charts the change trends of, forecast data; in other words, “how” forecast data are changing and evolving. Flexible charting capabilities in this feature tool allow users or analysts to choose what daily, weekly, monthly, quarterly or yearly (or other time period) forecasts they want to analyze, how long a change history to view, and whether to analyze by quantity, price, or revenue, or according other defined criteria. Key metrics advantageously inform users of the starting value, ending value, and the total change for the selected forecast data and range of change history, and may optionally inform users of other values and parameters.

The Change Chart Feature Tool Feature itself may advantageously include one or more sub-features, such as daily granularity or granularity as to particular tine intervals, Drag and Drop filtering, analysis by arbitrary defined and relevant measure, user specified inspection time range, and volume display, each of which are now described.

Daily granularity or other fine granularity (or dynamically determined time and data granularity) based analytics of forecast changes is presented using this feature. Since the system is lossless and does not need to resort to conventional snapshots, all data is preserved and can be represented in a trend. Recall that conventional snapshots involve predetermining the level of time granularity and require unnecessary storage need whereas by comparison the inventive system and method use a flexible storage model and way of organizing data that permits the system and method to describe data at any level of time granularity required by the user. Further to this, the time granularity or data and time detail could be driven down to the hour or the minute should the user or analyst desire such detail. This type of fine time and data granularity might be particularly useful when rapidly changing currencies are involved, during a period of time immediately following release of a new product or new product marketing campaign, for financial market predictions and forecasts, and for other situations where fine time granularity or short time intervals need to be tracked and analyzed.

There is also an ability to optionally but advantageously drag and drop items directly to the chart to have the item automatically filtered or processed in a particular way. For example, if one sees a customer or set of customers who's forecast contribution is negative, the user may drag it onto the display and then analyze the trend.

In one non-limiting example, the drop event is tagged to a notion of the category or dimension being acted upon. In other words, if one is dealing with the customers, this can be thought of as a dimension or hierarchy of which each member has a unique identifier. By dropping the member onto the chart the server receives a command to return a dataset or query result that uses the member as a filtering criteria and excludes all others not provided in the drop event. The query result is typically an analytical query by which a dimensional filter is applied for the given member that is received.

The system and method also provide a capability to analyze by any defined and/or relevant measure. If the system is set up to take predictions, such as future predictions for number of units, price, currency, exchange rates, and/or probability, or other predictions, then these can selected for plotting on the chart independently.

Furthermore, the user may specify the range of time or a set of time intervals, points in time, or the like, for which the user or analyst wants to inspect and analyze or alternatively select and drag and drop an area of the chart with the mouse or other pointing device or interface to further refine or alter the scope of analysis.

Volume of changes as well as forecast trend may also be displayed on the chart as was described herein before relative to the example in

FIG. 1. Not only may the user see how the forecast is trending over time but the user may also be presented with and view the volume of changes that have been made on a given day (or other defined period of time) in the lower most graph of the displayed chart. Given that most conventional systems incorporate spreadsheet based or snapshot based systems and methods to try and generate and reproduce a trend of forecast information, it is virtually impossible and impractical for such conventional systems and methods system to comprehend and use this information without having it manually entered. The inventive system, method, application, and computer program perform this task readily and easily without the separate manual entry.

The Multiple Forecast Plans Comparison Feature Tool feature with underlying system and method analytics engine and database support provides for viewing and/or analyzing multiple forecasts. These Multiple forecasts, which may represent sales forecast, product forecast, marketing forecast, actual shipments, sales targets, Annual Operating Plan (AOP) or other data or forecast data (whether of a business, financial, or non-business nature), can be charted together. This enables users to analyze and compare how different sets of forecast or actual data have changed over time.

One application of this capability is for performing detailed “what-if” scenario analysis, but more importantly, it may provide a tool and capability for users to compare either portions of the same forecast, or independently compare different forecasts, and their trend data in the same graphical view and provide the graphic interaction based query and analysis described elsewhere herein for any single forecast.

For example, if a user or analyst wanted to compare the trend of a given product line over 6 months and then subsequently compare the trend of a customer group over the 6 months, this can be done on one chart. One can then use change analysis to understand root causes of the changes in both cases and see if there are commonalities in the aggregated reasons for change that were entered, or perform other analysis referencing the two or more graphs, trends, or underlying data for the multiple graphs and trends.

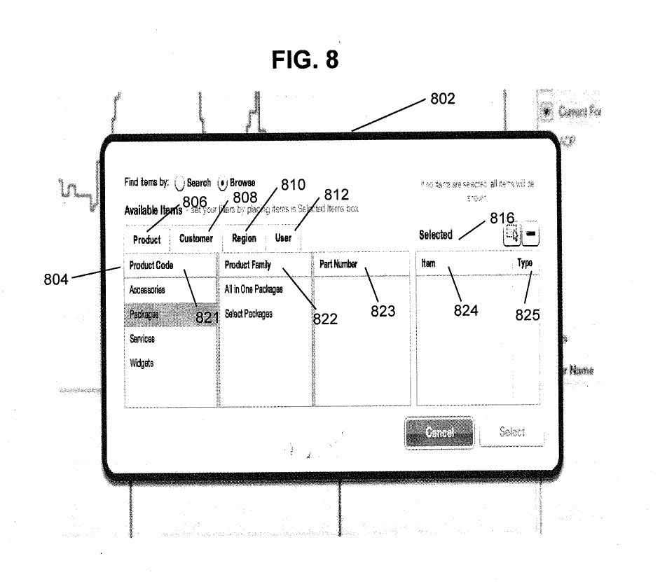

The Multiple Categories Comparison Feature Tool feature with underlying system and method analytics engine and database support provides users the ability to compare forecast changes by category for a single forecast, for example by customer, product, region, or user. FIG. 8 is an illustration of a graphical display screen and graphical user interface 802 that shows how a user would select this multiple categories comparison feature tool. This Multiple Categories Comparison Feature Tool interface window when selected may appear on top of the user display (such as over the trend line display portion that illustrated in FIG. 1) and as indicated by the background graphic behind the window in FIG. 8.

The interface provides tabbed pull down menus 804 such as in this example, for Product 806, Customer 808, Region 810, and User 812 parameters and provides an Available Items list. In this non-limiting example, the list of available items or choices may be a set of Filters 814 that are selected by placing the filters in the Selected items Box 816.

In this non-limiting example case, the display shows a product dimensional hierarchy and the user is choosing from three possible levels (Product Code 821, Product Family 822 and Part Number 823) from which to plot a chart. The user may select multiple items and have each one represented as a trend line on the chart for analysis. The level to which this can be done is made possible by keeping the information in the underlying database data structure effectively at the lowest level of transaction detail coupled with the ability to manifest this data at a daily level over a time period.

Forecasting data is captured in categories, these categories may be organized into hierarchies or dimension. In many cases, different types are used such as Customers, Products and Regions. When organized into hierarchies it is advantageous to capture or manifest the data at the lowest level of detail in order to facilitate the capability to analyze the data at that level of detail or depth. For example, if one is concerned with only “customer” and “product” and each has a hierarchy associated that has a depth of 2 (Depth=2) we would see something like the following:

Customer Level 1→Customer Level 2

Product Level 1→Product Level 2

If there is a need or desire to analyze the forecast data and it's changes over time at the lowest level of detail, the system and method need to ensure that the data is captured and stored at the level of Product Level 2 and Customer Level 2. Thus the system and method can aggregate the data up to the 1^{st} level of each and do analysis there but not forgo analysis at the lower level. In so much, we need to capture and tag data around members that are associated to the second level in each hierarchy.

This is achieved for example, by tagging each AOW/AON data change with a notion of element where element is an identifier (ID) combination that, in the case above, would be built with the ID of the forecasted customer member from Customer Level 2 and the different ID of the forecasted product member from Product Level 2. This affords the lowest level of details possible on the data. The different ID's should be at least locally unique.

One of the advantages of this capability is to provide the user or analyst many options and maximum flexibility in displaying and comparing the structures that they have defined for forecasting. This interface can be used to set up graphical and analytical views where a user wishes to compare multiple products or customers at the same time. Each would be represented by a line or graph on the chart. Alternatively, a given view can be further filtered by the users in whatever why they need. They could be looking at their current forecast and decide that they want or filter it (or selectively analyze it relative to some parameters or conditions) by a particular thing or parameter, say a customer identity or a geographical region or any other factor, parameter, or sets of such factors or parameters, but they are not limited and have complete flexibility in this regard.

The Change Summary Feature Tool feature with underlying system and method analytics engine and database support advantageously provides an interactive tool that helps a user or analyst to analyze and determine “why” forecast numbers have changed. The biggest change impacts, both positive and negative change impacts, may advantageously be broken down or analyzed by selected parameters, such as customer, product, region, forecast user, and/or other factors or parameters in a business or financial context. Different relevant parameters may be identified and utilized with the change summary feature tool in non-business environments, such as physical sciences or engineering forecasting, process control, inventory management, architectural and building planning and development, or in other fields where forecasting of event or conditions is involved.

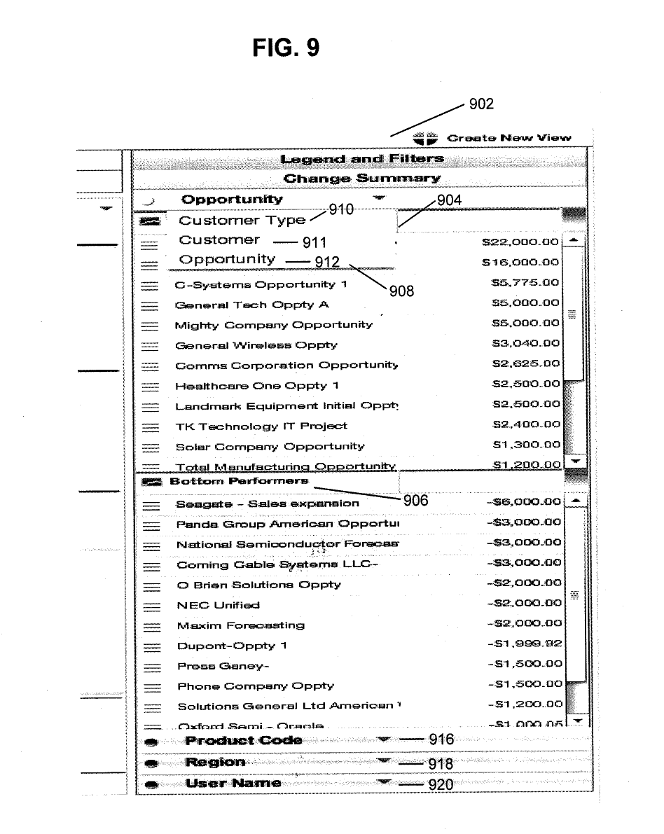

FIG. 9 is an illustration of an example Change Summary Feature Tool presentation 902 showing the top positive or top performers (+$ contribution) 904 and negative contributions or bottom performers (−$ contribution) 906 to the changes displayed in the forecast trend. (Note that the top performs heading is obscured in the display by the pull down menu showing the Opportunity choices: Customer Type, Customer, and Opportunity).) These are advantageously sorted in ascending or descending order or according to other selected or default sorting, ordering, or preference parameters.

By simply using the drop down menus for Opportunity 908, Product Code 916, Region 918, and/or User Name 920 (or any other desired drop down menu item) provided by the graphical interface, the user can drill up or drill down at different levels of the forecasting hierarchies to view the change impacts and related factors or parameter. In FIG. 9, this is illustrated in the pull down control allowing for selection from Customer Type 910, Customer 911, or Opportunity 912 which represents the currently configured customer dimension hierarchy. These selection would generally be different for different dimensions and different dimension hierarchies. Items from this list may be dragged onto the chart and in so doing operate as filters for which the chart is redrawn to include. The selection of filters for analysts is therefore provided in an intuitive and easy graphical interface supported by the underlying data structure.

The Change Details Feature Tool feature with underlying system and method analytics engine and database support provides a user with a detailed understanding of the individual change details that go into a given change to the forecast. The example in FIG. 10 illustrates an optional window 1002 that displays change details in a list and color coded manner (although the color coding may not be produced in this document), that is also reflected in a bar graph 1006 on the upper portion of the displayed graph. In this example, Customer 1010, Product 1012, Region 1014, Changed By 1016, Revenue Change 1018, Quantity Change 1020, Price Change 1022, Date Changed 1024, and Comment 1026 fields are displayed. Since the detailed transaction information is maintained in the system, method, and underlying database and data structure at the lowest (or most detailed or most granular) possible level, a transaction inspector is provided that gives the users detailed understanding of the individual change details that go into a given change to the forecast. Roll down or pull down lists or menus show about 6 entries out of the 100 Most recent changes that may be displayed with slider bars optionally provide so that a user may browse the list. These number of entries is of course user configurable.

Having now described some example features and tools, attention is now directed to some further technical details.

A measure is numerical value (or equivalent) that has meaning to the business or other event outcome being forecast, such as revenue, product price, unit cost, sales probability weight, time to market, or any other forecastable entity. Multiple measures may be combined to produce new composite measures. For example, a Quantity measure and a Price measure can be multiplied to produce a Revenue measure. A measure can be collected or calculated, and this distinction is a property of the forecast not the measure. For example a Revenue measure might be calculated from Units and Price in one case and be collected directly in another.

A dimension is an entity, such as for example a business entity, that is used in a forecast. Customer, Product, Region, Warehouse, Distribution Point, Shipping Date, and Billing Date are non-limiting examples of such dimension entities. An instance of a dimension is a member. For example, the member Acme Cube Movers is an instance of the Customer dimension.

Forecast Element(s) may include sets or tuples of members (M1, M2, Mn) drawn from a fixed set of dimensions (D1, D2, Dn). The set (D1, D2, Dn) defines the type of forecast element, and (M1, M2, . . . , Mn) is an instance of that type. One non-limiting type of element might be Customer, Product, or Billing Month, with a specific instance being (Acme, Giant Spring, January 2010).

A forecast value may be a set of measures, a forecast element and a set of values for the measures. For example (Units, (Acme, Giant Spring, January 2010), 1050) represents the forecast that 1050 units of the Giant Spring product will be sold to Acme and billed in January 2010.

The Forecast Date is the date of the forecast and (optionally) the time the forecast value is created. This represents the point in time the prediction that Acme will buy 1050 Giant Springs in January 2010.

A Forecast Stream may be a series of (forecast value, forecast date) pairs for a specific forecast element, representing how the predicted forecast value for the element has changed over time. For example, for the (Acme, Giant Spring, January 2010) element on Dec. 12, 2008 at 2:43:12 PM GMT we predicted 1050 units, and then on Jan. 15, 2009 at 3:34:44 AM GMT we update that prediction to 2500 units. A Forecast may be a collection of forecast streams for forecast elements of the same type.

Deltas or changes or variances are difference values or expressions between adjacent forecast values in a forecast stream. The inventive system, method, and application makes extensive use of the deltas and changes and the manner in which these deltas or changes are calculated, stored or not stored, and accessed contribute to the beneficial features described here.

It may be understood in light of the systems and methods described herein, including both the innovative features and the problems and limitations of the conventional approaches, that most transactional systems will receive numeric data in an absolute form to decrease the time and expense of insertion. In order to create a chain of data or information that describes the evolution of a measurement over time it is necessary to store data in a more complex way in order to meet the demands of the innovative comparative system described herein. Essentially there are three questions that the system must answer or their equivalent. First, what is current value? Second, what was the value at a point in time in the past? Third, how much has the value changed between two points in time?

In a simple sense, changes propagate into the system in the two forms simultaneously. A simplified table (Table I) representing this and the evolution of change would look like the following example:

TABLE I

| Date | AOW | Variance |
|---|---|---|
| May 1 | 10,000.00 | +10,0000.00 |
| May 10 | 10,750.00 | 750.00 |
| May 18 | 9,500.00 | −1,250.00 |
| May 22 | 9,250.00 | −250.00 |
| May 29 | 9150.00 | −100.00 |

Structurally, the system and method maintain the values submitted and received as well as the derived value from the previous measured point in time. By tracking these two values the system and method can answer the above three questions simply, to a high level of detail and it allows once the innovative approach is appreciated for simple aggregations in an analytical system. In order to answer the as of now (AON) question, the innovative system and method takes the last value of the last record in the chain. To answer the as of when (AON) question, the system and method take the maximum record found prior to the date under inspection. For example, the AOW value for May 20 is the value entered on May 18. Determining the variance is then determined by summing the variance values on or within the date range values desired.

Until the present innovation described here, deltas, or differences if used at all, have always been calculated and stored and stored in advance of any identified need for^{e} them. One key departure from this conventional approach in the present innovation is that the deltas. Changes, or differences in the innovative system, method, and application are calculated on the fly in real time or substantially in real time as they are needed. By substantially in real time is meant within a short period of time, such as with less than a few seconds to a few minutes and in response to an inquiry requiring the information being made. Deltas, changes, or variances may alternatively or additionally be stored or materialized after calculation, but this is not required or preferred. In some non-limiting embodiments they are only calculated on-the-fly when needed and then either not stored and discarded or alternatively stored. In some non-limiting embodiments, the deltas or changes are stored whenever calculated. These are implementation specific customization details that may trade off computational efficiency versus storage and retrieval issues. In at least one example, the deltas are generated on-the-fly in real time and not stored after the immediate need and use has passed.

A Composite Forecast is a combination of two or more forecasts. For example, one might combine a “unit price forecast” with a “quantity forecast” to produce a composite forecast that contains unit price, quantity, and the measure revenue calculated as unit price×quantity. The combination or composite forecast is typically at the individual forecast stream level. The forecasts that make up a composite forecast may also or alternatively be referred to as component forecasts. If the element type of a component forecast does not match the element type of the composite forecast it is advantageous to define a many-to-1 or 1-to-1 mapping from the component forecast elements to the composite forecast elements. The forecast stream in a composite forecast may also be referred to as a composite stream.

Generating a Composite Forecast may require a Composite Forecast Loading process. In one non-limiting example of such process, the steps to load a forecast value “V” for a forecast element “E” from a component forecast stream “F” into the composite forecast stream includes the following steps.

First, (1) create a new node in the composite measure stream for the element E.

Second, (2) set the current values for measures from F, taking the values from the forecast value V.

Third, (3) find the previous composite forecast value for the element E.

Fourth, (4) take the previous measure values from the previous composite stream node.

Fifth, (5) for measures not from the forecast F, set the current values equal to the previous values.

Dynamic deltas are the change or delta values for measures, optionally including cross-forecast calculated delta values, and are derived or calculated on-the-fly as needed in real-time or substantially in real-time in response to a query or analysis task explicitly or impliedly identifying a need for the delta value or values. Consider a composite forecast C built from individual forecasts F1, F2, Fm. For a given forecast element (F1, F2, Fm) we will have the following forecast streams where the V are forecast values, and the T are forecast times:

F1: V1_1, V1_2, . . . , V1_n1 for forecast times (T1_1, T1_2, . . . , T1_n1)

F2: V2_1, V2_{—}2, . . . , V2_n2 for forecast times (T2_1, T2_2, . . . , T2_n2)
. . .

Fm: Vm_1, Vm_2, Vm_n1 for forecast times (Tn_1, Tn_2, Tn_nm)

The composite forecast stream C will then be:

C: Vc_1 , Vc_2, Vc_nc for forecast times (Tc_1, Tc_2, Tc_nc).

For each node in the composite forecast stream we record three parameters in a data structure:

(1) The source forecast;

(2) The forecast value that was in effect for each forecast; and

(3) A pointer to the previous node in the composite forecast stream, giving access to the previous measure values.

This means that for all the measures M1, M2, Mp in all the forecasts F1, F2, Fn; and for each node in the composite measure stream we have the current and previous measure values. If a calculated measure is expressed as F(M1, . . . , Mp) then its deltas are calculated as F(M1, . . . , Mp)-F(M1′, . . . , Mp′). Where the primed measure notation M1′ denotes the previous value for unprimed measure MI. Deltas for the base measures M1, M2, Mp are the special case where F(M)=M.

The Change Reasons parameter or field is pertinent to the inventive change analytic method and procedure. An advantageous aspect of the Change Analytics based system and method describe here is the ability to break down a net change into individual change reasons. Each node in the composite forecast stream is tagged with (i) a source forecast, and (ii) a change reason. This means that each delta is tagged with a change reason. By aggregating deltas across change reasons the inventive system, method, and application are able to break a net change down into its constituent change reasons.

Change Trend provides another view in the Change

Analytics method procedure and in the end of day (or other end of period) summaries. To get the value of any measure at the end of a forecast day (or other forecast period) the innovative method and procedure aggregate the deltas for all nodes in the composite forecast stream that were created on or before the date (or other identified relevant period).

Because it is able to determine complex calculated measure values at any date in the past it is able to perform variance calculations that are more advanced than simply comparing A to B; we can compare what the forecast for A was on some date in the past to what the forecast for B was on some day in the past. Additional aspects of change, delta, and variance calculations are provided elsewhere and are not repeated here.

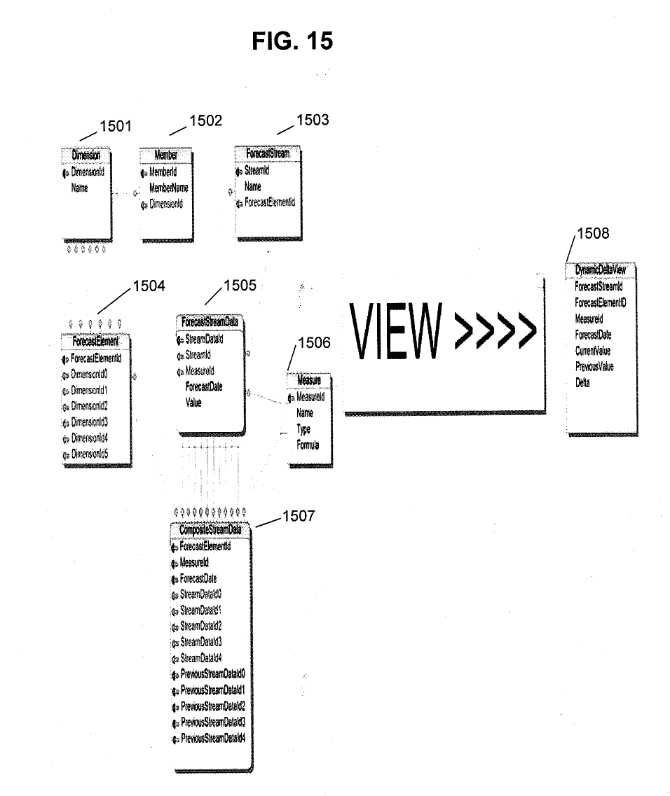

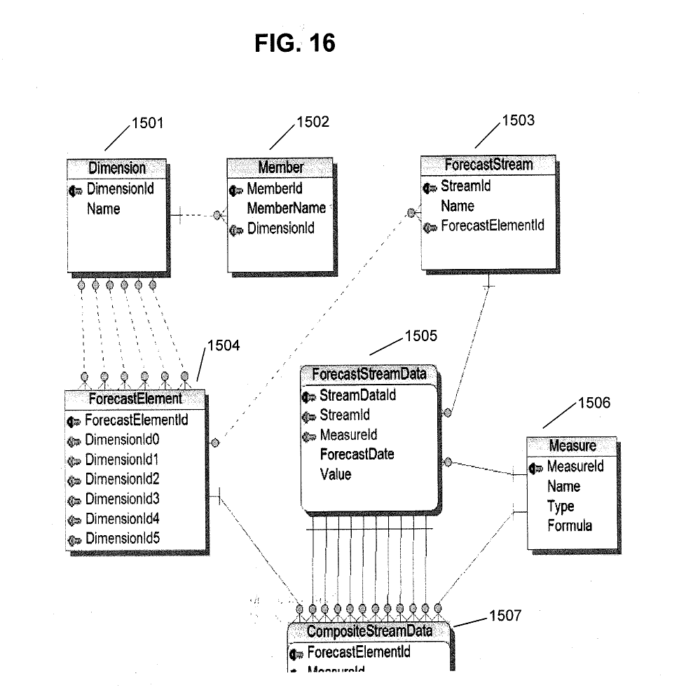

Although there are various alternatives for implementing some features of the inventive system and method, one may for example use a Relational Database Management System (RDBMS) which is a database management system (DBMS) that may be based on the relational model RDBMS such as SQL Server 2005. A database management software system of this type may organize data into a set of records that are stored in linked tables. This provides the ability to relate different records, fields, and tables to each other, and aids data access and any required data transformation. Features and aspects of the data structure and database are illustrated in FIG. 15 and FIG. 16, where FIG. 15 is an illustration showing features and aspects of an example data structure and database including Dimension 1501, Member 1502, forecast stream (ForecastStream (1503, forecast element (ForecastElement) 1504, forecast stream data (ForecastStreamData) 1505, Measure 1506, composite stream data (CompositeStreamData) 1507, dynamic delta view (DynamicDeltaView) 1508 and their relationships to each other and as they contribute to generating and presenting a view, and where FIG. 16 shows a somewhat magnified view of portions of FIG. 15.

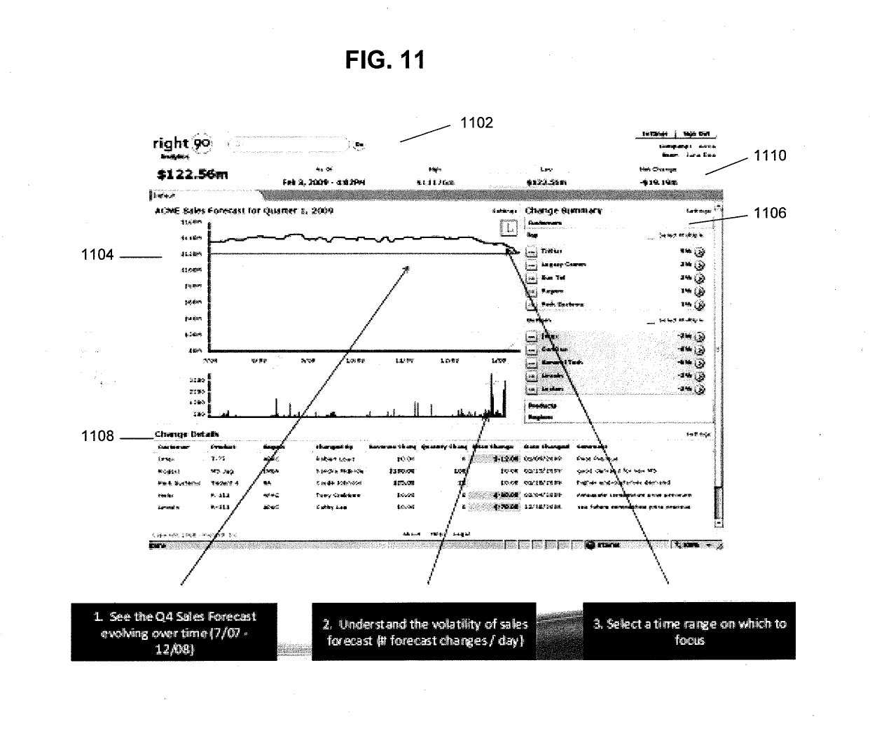

FIG. 11 is an illustration showing an example screen display or dashboard 1102 view showing the manner in which sales forecasts have evolved over time, display portions that assist in understanding the volatility of sales forecasts such as the number of forecast changes per day, and a window that permits selection of a time range on which to focus analysis are shown. For example, in the example shown there is a first window 1104 for the Sales Forecast per Quarter, a second window 1106 showing a change summary, a third window 1108 showing change details, and a fourth window 1110 or data bar showing additional text and numeric information with optional pull down tabs or menus.

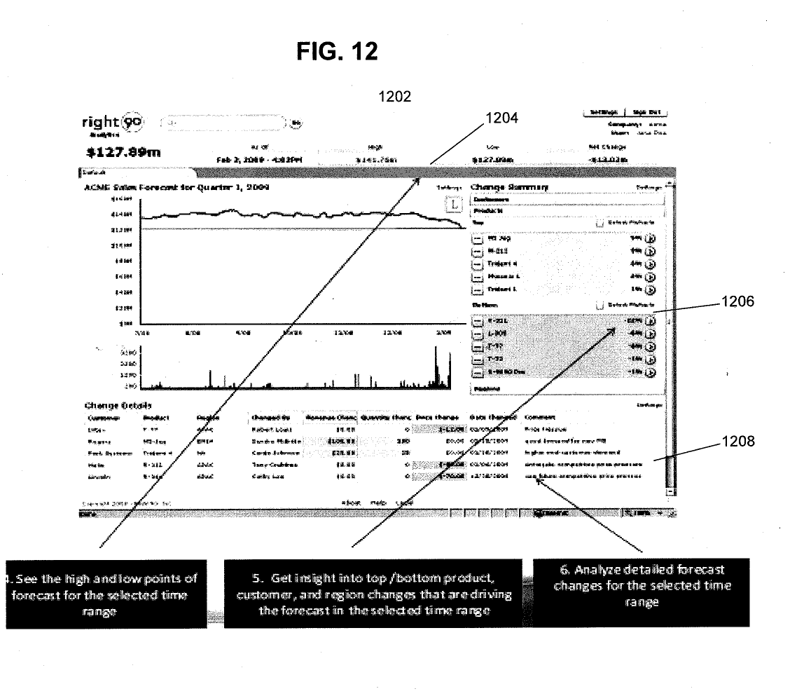

FIG. 12 is an illustration showing another example screen display or dashboard 1202 view highlighting a window 1204 portion of the display with high points and low points of the forecast for a selected time range, a display window 1206 for obtaining insight into top and bottom product, customer, and region changes that are driving the forecast in the selected time range, and a window 1208 for analyzing detailed forecast changes for the selected time range.

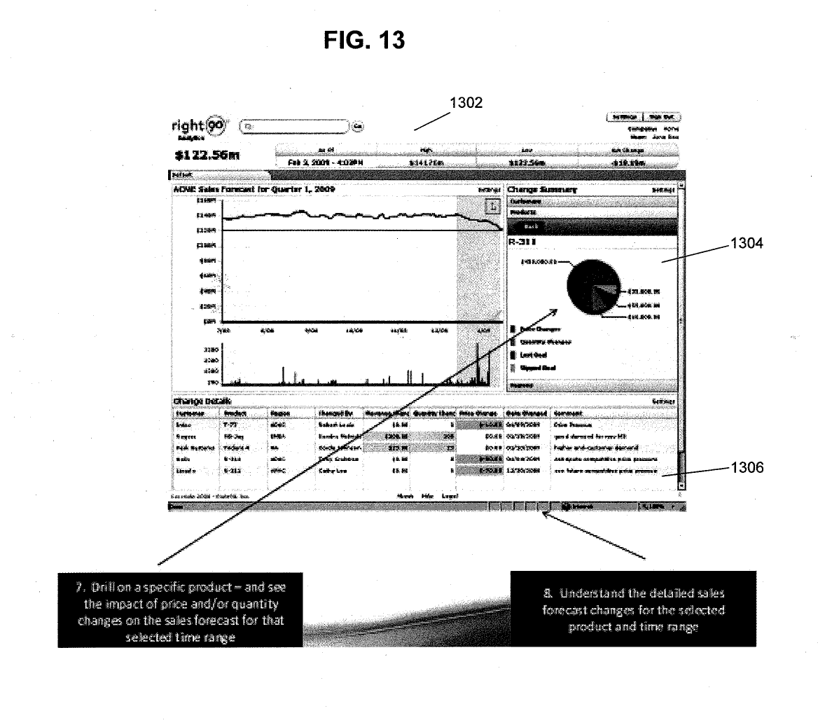

FIG. 13 is an illustration showing yet another example screen display or dashboard 1302 view with a window 1304 portion of the display for drilling down on a specific product and for seeing the impact of price and/or quantity changes on the sales forecast for that selected time range, and a second window 1306 portion for understanding the detailed sales forecast changes for the selected product and time range.

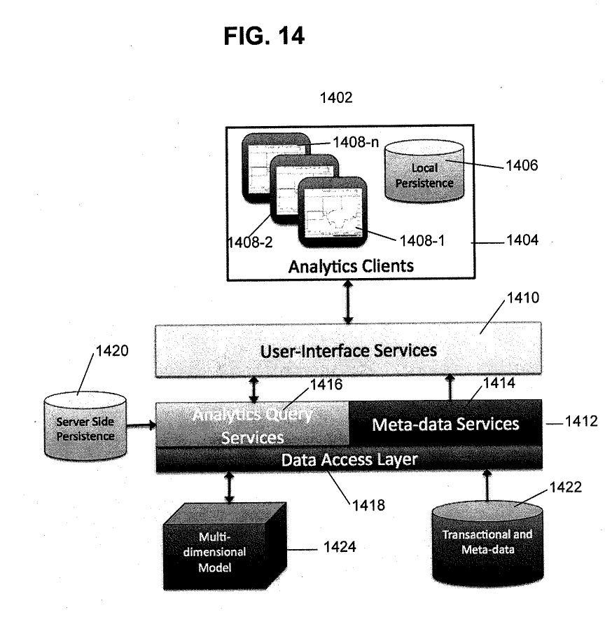

FIG. 14 is an illustration showing and block diagram of an example system 1402 that may be used to implement aspects of the invention. The application is based on the coupling of a multi-dimensional mode processing engine (an example being an OLAP) and a relational database and database structure and model to store the forecast updates and the metadata that describes the dimensions and other configuration information. A data access layer server to process request to both the multi-dimensional and the relational database systems. Above that are situated handlers that expose services for retrieving data and, in the case of the relational system, inserting data.

The external analytics clients 1408 or clients devices includes a web-based application viewer that allows the users of the system to view and analyze the data housed with the system. The analytics clients 1408 may also be part of the system. The viewing application is delivered using HTML or other web delivery technology. Ideally the system persist 1406 certain data within the remote client instance in a local storage cache but will also dynamically retrieve data from the server via a collection of services 1410 as necessary to complete the view being requested by the user. The services 1410 are powered by two primary subsystems, the meta-data services 1412 that describe the underlying data and the analytics query services 1414 that provide the underlying data. The meta-data services 1412′ are firth accessed to provide the users of the client application 1408 with informational data describing what can be queried in the systems. Using that data the analytics query services 1414 are then called to service specific application questions that are formulated by the users of the client applications 1408. Data on the server related to the meta-data or query data may be persisted in a server-side cache 1420 for performance reasons. Meta-data is provided to the system through relational database instances 1422 and analytics query data is provided through an multi-dimensional analytics system or OLAP cube 1424. All data between the services, 1416 and 1414 and the data providers, 1424 and 1422 are brokered through a Data Access Layer which is a collection of services that abstract the specific queries and requests into an object library for faster development of features and services.

The services layer, 1410, 1412 and 1418 is advantageously housed within a server but may also be split across multiple servers or replicated in whole across multiple servers, forming a cluster. This can and would be done for performance reasons for satisfying high volumes of service requests. The data systems, 1422 and 1424 are also housed on servers, most likely not the same physical instances as the services layer and not necessarily the same class of hardware. Both the meta-data and analytical systems may coexist in the same physical server but may also be separated to allow for independent scalability. The Analytics Query Services process 1416 requests (described earlier) and subsequently returns the required data for the clients. The Meta-data Services 1414 support requests for detailed forecast update records as well as supply the clients with the necessary meta-data describing the dimensions, levelspaces and measures as well as a variety of other supporting data. The User-Interface Services 1410 expose necessary methods and services for the client applications. These services are exposed in a web-enabled protocol. Server Side Persistence 1420 allows for server side storage of View Request objects and user session information for rebuilding the client views on exit and return to the application. The local persistence 1406 is an optional but advantageous optimization that allows the views to be constructed without returning to the server to do so. While the data for the views still needs to be retrieved from the server this local persistence storage 1406 allows for quick recovery from communication errors and session switching without a trip back to the server to retrieve or otherwise access the view data.

Having described a non-limiting embodiment of an entire system and method, it will be apparent that the innovations described here also provide for separate server side, database side (which may also be located and coupled with the server or located separately from the server), and client side configuration and operation. For example, a client side customer, user, or analyst may access the forecasting system and/or variance engine from a remote location over an electronic connection (such as for example, over the Internet or other network connection) and send forecast query information, data, and parameters to the server computer on which the variance engine is executing, and receive back the desired forecast information, graphical presentations, and the like information and results generated. This may operate in an interactive and real-time mode. For example, it may operate under an ASP type mode of operation. Both server computer structure and operation including the variance engine, database structure and operation, client or customer or user side configuration and operation, and the interface are aspects of the innovation that are covered separately and in any combination by the innovation described here.

Having now described the system and method from many different perspectives, including but not limited to its features and advantages, functions and operation, and user interface perspectives, additional attention is directed to some additional example invention solution implementation details.

It may further be appreciated that the resulting analytical data and forecasts may be used to make concrete and tangible decisions in the business, financial scientific, and technological fields, among other fields. For example, not only may the generated results and forecasts be viewed and displayed, but they may further be fed directly into manufacturing, inventory, stocks or bond or other financial instrument trading system or the like to control these processes.

In another aspect, the inventive system, method, and application provide a variance engine that captures changes from the forecasters in a way that manifest the data in both change forecast as well as absolute numbers (forecast increased 10 units, current total is 100 units).

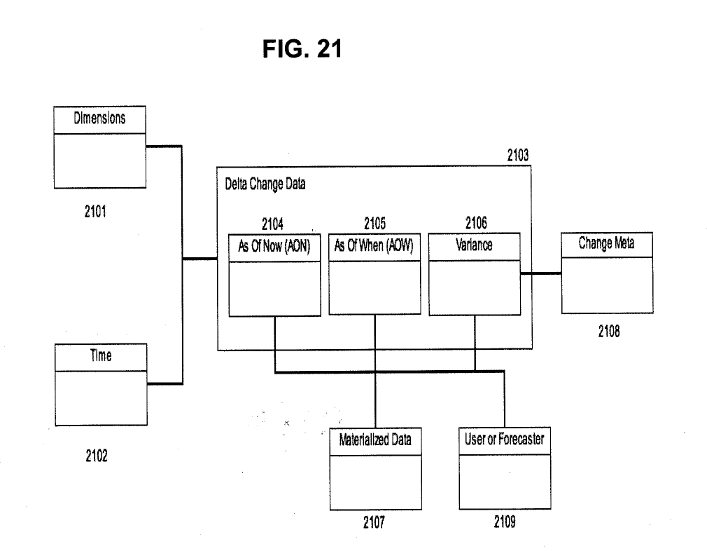

With reference to FIG. 21, aspects of the variance engine are now described. In one non-limiting example, the variance engine which may be implemented as special purpose hardware, or in general purpose hardware with executable special purpose executable computer program code to provide the innovative method and process.

In one non-limiting example, the variance engine provides a structure and executes a process combining data elements organized in such a way to be conducive with highly granular variance analysis coupled with a process for assembling the necessary data. Examples, of the process are described earlier in association with other of the figures, including with reference to FIG. 21. Here we will describe the data structures and relationships from a different perspective and with some additional detail.

Data is categorized in a couple of key ways. Firstly, dimension 2101 are used to segment the forecast data into categories that may be further defined with hierarchies. An example of one such dimensional hierarchy is a product catalog whereby product items, roll up into product classes that roll up into product families. In addition, data is necessarily associated with time 2101 in that when a change is made to a forecast item it necessarily is associated with the exact time for which the change was made. In other words, the change was made “as of” (AOW) a point in time. As time progresses and no further changes are made, the AOW value is deemed the “as of now” (AON) value until such as time as it is again changed at which point the AON value is deemed to be that new value.

Change data should be defined in a number of ways 2103. Firstly, as mentioned before, it needs to understand and store data in both a sense of AON 2104 and AOW 2105. These values are maintained separately for easy retrieval from the system and method and database structure. What is derived from these two values is the variance itself 2108. The difference between the new AON value and the last AOW values is the variance associated with the forecast change. These three data concepts are further extended in a more complex notion of a materialized or related value 2107 that system needs to understand in forecasting scenarios.

An example of this is a revenue calculation or and exchange rate adjusted price value. Specifically, if users or analysts are forecasting quantity and price either in conjunction or in isolation, it may be the case that revenue is desired so that the revenue calculation is simply quantity multiplied by price. In this case the act of forecasting a change to say price necessarily triggers a materialization of the new revenue number. Finally, any associated commentary, annotation or structured change reason or type 2108 is associated with the variance data as additional meta data to the change, preserving a kind of transaction log or, if you will, chain of accountability. Changes, as they are made are not only associated with the users or forecasters 2109 but the reasons and or insights as to the reason for the change are preserved.

In another aspect, the inventive system, method, and application provide a multi-dimensional analytics scheme that models this data in a way conducive to change analysis. Necessarily, the system must capture data along dimensional lines that are relevant to the particular forecasting that is being performed. In a simple sense this can be, but is not limited to, Customers, Products and the Regional information as well as the personnel doing the forecasting. In other words, forecast data should be categorized into dimensions, hierarchies, and/or logical groupings that allow for the detailed aggregation and analysis in a traditional multi-dimensional analytics or OLAP system or engine. By categorizing the data into these dimensional concepts, the users may analyze the data within in aggregate form allowing for higher-level questions to be formulated and answered.

In one simplified example, if one assumes customers are grouped into Accounts and Projects where Projects roll up into Accounts, one has what can be described as a basic dimension or hierarchy describing customers. If one captures the necessary variance data at the Project level then one can then aggregate the data to the account level with multi-dimensional analytics techniques or OLAP concepts. Thus, a user can understand the change described in the system and method both from the point of view of the particular Project, as well as the particular Account that the Project or multiple Projects roll up into.

In another aspect, the inventive system, method, and application provide a data model that stores data in a variance and absolute form and does so in an optimized way so as to provide an efficient storage mechanism. This assists in avoiding data volume explosion in that it is predicated on the notion that you only store what has changed and avoids intense snapshot storage.

By comparison, in typical snapshot type systems and methods, the cadence of the granularity of data typically needs to be understood ahead of time. If the system or method wishes to summarize the current forecast values each Sunday what typically needs to happen is that the values for the forecast need to be summarized and materialized in the system to “As of Sunday” as well as preserving the discrete changes. This is sub-optimal at least because it may be the case that the last changes may have been earlier in the week, say on Wednesday. Since weekly is typically not enough time or data granularity and in fact it is the case that a system or method ideally would allow for the user to inquire as to the “As of any point in time” value, the gathering, generating, or manufacturing of data to provide snapshots is costly in one sense and non-workable in the spirit of the solution. Generating or manufacturing the variance as described earlier according to the innovation here allows for the summing (or other arithmetic or analytic operation) of data at any point in time in order to retrieve the data at the point in time, any point in time, that the user is requesting.

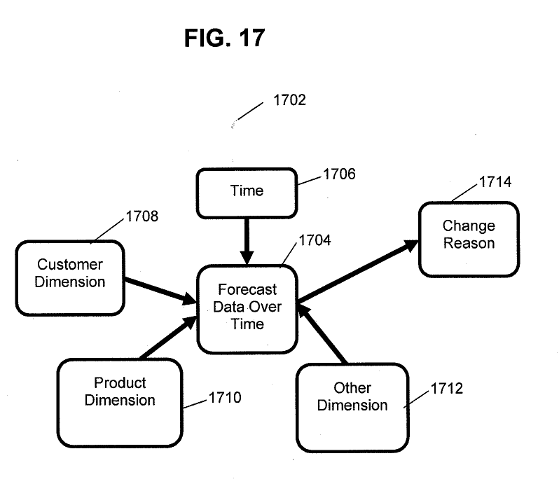

In another aspect, the inventive system, method, and application provide features that are configurable by the organization in that they can define how they want to model the data. Configurable as to what dimensions to include, what levels of slicing they wish to use and what metadata they wish to include for additional context. Companies can define the core dimensional structures they need such as, but not limited to, customers, products and regions. Additionally, these dimensions can be constructed in a tree form at a depth that the customer chooses. In a further abstraction, definition of reason meta data may be created as a lookup to the forecast data and the user can be forced to choose the reason for change when entering forecast data. In-so-much as this guarantees that forecast data is classified correctly indicating the reason for change. This data is then aggregated through the use of multi-dimensional analytics and can be understood in multiple levels of detail. FIG. 17 illustrates an example of the configurability. In the illustrated example, a forecast data over time 1704 may receive one, any combination, or all of: a time input 1706, customer dimension 1708, product dimension 1710, other dimensions 1712, and change reason 1714.

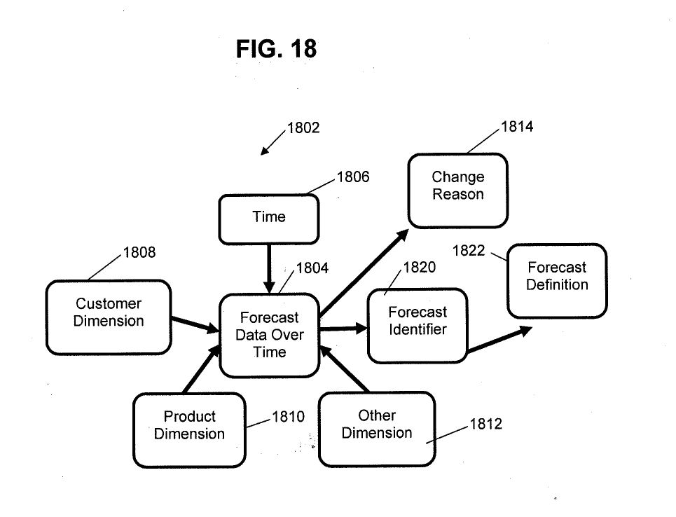

In another aspect, the inventive system, method, and application provide for different forecasts to be tracked separately in different forecast constructs and then their corresponding change data may be analyzed side-by-side. By adding a notion of a Forecast Identifier 1820, forecast data may be kept separate inside the system and database while using the same dimensional setup. However, each forecast represented with a forecast identifier, does not necessarily need to use the same dimensions as other plans. The notion of a forecast definition 1822 allows the forecast to be defined such that one uses certain dimensions and the other uses either the same, some of or completely different dimensions as the other. Various forecast representations are illustrated in FIG. 18 where the forecast identifier 1820 and forecast definition 1822 are added to the configuration as compared to the configuration of FIG. 17.

In another aspect, the inventive system, method, and application provide meta-data constructs like Product and Customer mention earlier may also be analyzed side-by-side. In other words, a user may take a group of for example, ten products and wish to analyze the selected ten products together so that commonalities and/or differences may be isolated and understood.

In another aspect, the inventive system, method, and application provide for multi-tenancy in the design so that these flexible data models and analysis constructs can be operated together in the same deployment environment. Each customer is given a logically separate instance of both the data model contained in the database and the analytical model contained in the multi-dimensional system. While customers may share the same hardware this is not a limitation. Individual customers, where needed, may be given access to dedicated systems permanently or for temporary periods where this is necessary or desired.

In a deployment model that affords multiple customers or entities (e.g., multi-customer or multi-tenant deployment environment) the benefit of the solution, should necessarily be the case that the system and method maintains flexibility in its deployment. In a multi-tenant environment, it may be the case for reasons of cost or performance or scalability that customer data and systems be located physically on the same instances of hardware or separated on physically different systems. Requests being serviced from the clients should be predicated with an identity and the system and method (including database access and security) should be able to broker request from a particular user or customer identity to the appropriate hardware that the customer's data is served from. The system is advantageously flexible enough to allow for mapping of requests to the appropriate customer services based on their current physical location at that time recognizing that the deployment may need to change based on the reasons described.

Aspects of forecasting systems and methods using change data based database storage for efficient ASP and web applications are described co-pending U.S. patent application Ser. No. 12/264,123 filed 3 Nov. 2008 entitled Forecasting System And Method Using Change Data Based Database Storage For Efficient ASP And Web Application which is assigned to Right90, Inc. of Foster City, Calif. the same assignee as the present patent application and naming as inventors Kim Orumchian, Art Stabenow, Dean Skelton, and David Petiot; and which patent and patent application are hereby incorporated by reference.

U.S. patent application Ser. No. 12/264,123 is a Divisional application of and claims the benefit of priority to U.S. patent application Ser. No. 11/116,143 filed 26 Apr. 2005 entitled Real-Time Operating Plan Data Aggregation, now U.S. Pat. No. 7,447,718 that issued on 4 Nov. 2008, which application claims priority to U.S. Provisional Patent Application Ser. No. 60/565,758, filed 26 Apr. 2004, each of which patents and patent applications are hereby incorporated herein by reference.

Other or additional aspects of operating plan data aggregation system with real-time updates are also described in U.S. Pat. No. 7,558,784 that issued on 7 Jul. 2009 from U.S. patent application Ser. No. 11/115,970 filed 26 Apr. 2005 and is also assigned to Right90, Inc. of Foster City, Calif. the same assignee as the present patent application and naming as inventors Kim Orumchian, Art Stabenow, Dean Skelton, and David Petiot; and which patent and patent application are hereby incorporated by reference.

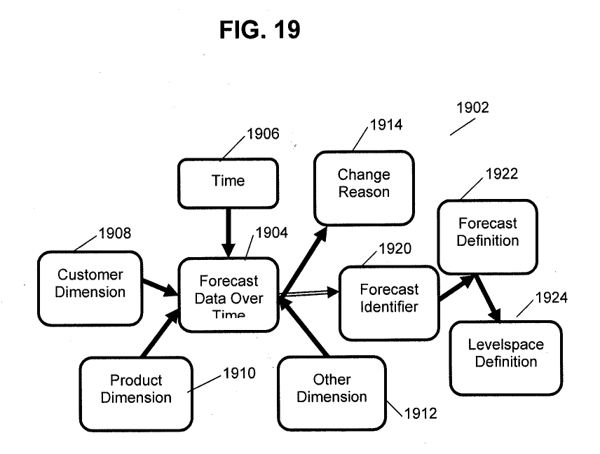

In another aspect, the inventive system, method, and application provide for multi-level forecast analysis by allowing each separate forecast, represented by a separate forecast identifier, to be defined at a different level of dimensional detail. This is through the use of a new forecast definition construct called levelspace and level space definition 1924, as illustrated for example in FIG. 19.

Each forecast may be defined not only for their own dimensions, but also for different depths in the hierarchical model. For example, If we have two forecasts, both using the Customer dimension and Product dimension and those dimension both have three (3) levels of hierarchical detail to them which we will define generically as Customer Level 1, Customer Level 2, Customer Level 3, and Product Level 1, Product Level 2, and Product Level 3.

It may be the case that the first forecast only uses down to Level 2 of the customer dimension and product dimension, while the other forecast uses down to Level 3 of both customer dimension and product dimension. This is indicated in the system as the first forecast having a levelspace of 2,2 and the second having a levelspace of 3,3. Within the inventive method including the change analytics, this levelspace information is tracked and understood by the system and method allowing the interface to alert the user that the comparison of these two plans is valid only down to Level 2 of both dimensions. Anything deeper would not be useful since the first forecast does not store data below level 2. Some other aspects of multi-level forecast are illustrated in FIG. 19.

In another aspect, the inventive system, method, and application provide a difference in the depth and richness of the data that is stored and modeled in the solution as compared to conventional attempted solutions. This is because of the intersection of the inventive dimensional flexibility, forecast definition capability, coupled with flexible level space definitions. Not only can the user analyze specific components of the forecast such as a given Product Family, or Geographic area, they can also or alternatively choose to arbitrarily break down that component into sub-components should the organizations specific configuration allow for it. As an example, if a users sees that a given geographic area's forecast is trending down and for the sake of example they further note that the reason for this trending down change is price pressure, they can then chose to break down the Geographic change by products to understand which are the root cause of the change and/or find if there is also a customer pattern related to this as well. f

In one non-limiting example, this is achieved by the combination of the variance storage model combined with the organization of the data into dimensional structures. By combining the variance storage model and the dimensional structure and organization the system and method can analyze the difference of a forecasted item from one point in time to another point in time and aggregate it up the dimension(s). This provides a novel and unique capability and advantages especially when combined with multiple-dimension as in some of the multiple-dimensional implantations. The aggregations over the variance may be sliced and diced (analyzed from different dimensional perspectives and/or with respect to different parameters) by multiple dimensions. For example, it may be by: variance from point a to point b sliced for Region X sliced by customer family y, or Sub-region Q sliced by customer group F. The end result is the ability to highlight variance over a period of time at a higher level in one dimensional space and break it down by another dimensional space at whatever level-of-detail is warranted for the analysis.

Within the method or procedure such as may be provided by a computer implemented method or application program executing in a processor and memory of a computer, view request objects are defined and represent the required query the users wishes to run to build their analytics view.

A suitable request for data should offer the ability to answer an analytic question on the variance by providing the data to satisfy the following by a non-limiting example:
For a given dimensional thing (customer, product, or the like)
   At a given level of details (customer family, product SKU, or the like)
For a given period of time (from date, to date)
For a given unit of measure (quantities, revenue, etc.)
On a given forecast construct (the sales forecast, the marketing forecast, etc.)
Tell me the dimensional things (customer family, product SKU, etc) that have changed.
And plot or other wise display them either in grand total form or broken out into the things I requested.

Another way of looking at this is by way of a concrete English language queries or questions:
From May 1, 2009 to May 7, 2009, I want to know what Customers caused my region's Sales Forecast Revenue to fall and I want each one plotted on a historical graph to see the trend they followed during that time?
From May 1, 2009 to May 7, 2009, I want to plot my Sales Forecast net revenue for a particular Region?
From May 1, 2009 to May 7, 2009, I want to plot Product A, Product B and Product C form my Operations forecast by total quantities forecasted?

This structure also allows the system and method a way to analyze change information across wide subsets of information that can be arbitrarily defined as described previously using dimensions, plan definitions and levelspace definitions. This querying structure supports request of the like where the forecast data could be filtered for a set of products, such as for example a set of 200 products, so that the trend can be analyzed for those selected products alone. Just as easily, the user could choose and large set of customers to analyze. The system can take as few or as many of these filters that the user deems necessary or desirable to present a forecast trending view of this data as well as a summary of all (or some partial subset of) the reasons for change across this filtered subset. The trending data is encapsulated in a data structure which pairs the forecast data with the day that the forecast was entered and/or adjusted. This structure is called TrendDataObj and is shown below partly in pseudo code.

Trending data is manifested as a collection of points plotted on a trend graph and/or stored in a database or data structure to capture the trend points or graph relationship. Each point is atomic and is provided by the server in a collection of related points making up the trend graph plot line on the graph. Each point is a combination of the date at which the forecast was measured and the measure that was taken (for example, revenue, quantity, or the like) for the item being analyzed (a product, customer or other dimensional item).

In another aspect, the inventive system, method, and application provide that changes are stored in the forecast are aggregated up the dimensional hierarchies and displayed in the application through views like that depicted for example, in FIG. 9. Here we see positive and negative changes displayed for a given forecast on the Customer dimension. It can also be seen here that there are 3 levels to the hierarchy so in this example the levelspace would contain a 3 for the customer dimension for this plan. In one case these “forecast impacts” are requested by the user or analyst by stating that they wish to see all of the impacts for a particular dimension, at a particular level. While this is a valid use case the system supports it limits the user to having to know where a particular change occurs.

Another method which aims to aid the user in finding the largest forecast impacts at all levels and across all dimensions is “forecast impact percolation”. This is a form of data mining that systematically goes through the dimensions and dimension levels and looks for the largest impacts based on a threshold. A user may specify that they wish to find all the impacts that have either been positive or negative and have exceeded either an absolute or percentage change and surface them in the example.

Although some generic forms of data mining are known as are certain types of multi-dimensional analysis. The discovery and use of data mining changes and/or variances as well as the type of multi-dimensional analysis in combination is novel and innovative. It provides new breadth and specificity of questions and answers.

For example, the innovative system and method can answer questions such as the following: Over a given time range what are the specific products that have change and how and by how much have they contributed to a change in forecast?

In a net neutral scenario where the forecast at a high level seems unchanged (neutral change at a high level), the system and method can pull out variance values for things that have netted or canceled out so that there appears not to have been a net change. This can happen, for example, when a product mix shift happens where demand moves from one product to another product but the net change in revenue for the combination of the two products is around 0. Unless one can pull out variance values from a lower or more detailed level, the shift or change is obfuscated from the high level number. The use of data mining on the variance data (variance mining) allows this to be done easily and quickly.

This method and algorithm traverses the dimensional structures and adds the forecast impact value to a return structure if a parent of it has not already been added with the same value. This ensures that the procedure returns the impact at the lowest level of relevance and not duplicated over and over at each level in the hierarchy for the exact same impact value.

In another aspect, the inventive system, method, and application provide for preserving a view of change data that is maintained by storing the distinct view request objects (definition describe earlier) either locally in the applications web cache or remotely on the server in the database or in the file system on a storage device. Analytics session driven view requested objects that are persisted may be recreated on return to the application. The use of multiple view request objects allow for the creation of a tabbed or windowed interface where each analytics view can be switched between on the fly by selecting the appropriate tab or window.

FIG. 20 illustrates a non-limiting example of a process by which data travels into the system and is processed according to the innovative methods and procedures, and that is manifested into the constituent components for variance analysis. Essentially, data is received 2001 either through direct input through a user interface or via data transmission or my other means. The value received represents the current or “as of now” (AON) value and that AON value is stored in storage as such 2002. It is then determined 2003 whether the element received has a previous value associated to it. If it does 2004 the received AON value is used against the previous value to determine the net change or delta required to achieve the change. That delta is also stored as the variance.

As new AON values are received, any previous or earlier or old AON values are treated as “as of when” (AOW) values from that point on since their notion of current has been superseded by the new AON value. If no previous value exists 2005, the AON value is treated as the variance (VAR) since it is assumed according to at least one non-limiting example, that all forecasts start at zero. Other initialization situations and assumptions may alternatively be used.

If optional but advantageous commentary or annotation was supplied 2006 with the change it is stored in association to the variance measurement. Stored in association, may for example be storing it with the variance, stored using a pointer to it, stored with a common identifier or tag, or in other ways that are know for storing and associating or linking related data or information items.

If the value supplied is a member of a pre-defined composite calculation 2007, the composite values are materialized in the system 2008. By way of example but not of limitation, if the change received was simply for price but it is deemed that revenue composed of price multiplied by quantity, the revenue number will be calculated and materialized. Analytics system(s) are then instructed to refresh and re-calculate necessary aggregations 2009. At this point, the system can supply updated analytics numbers through a user interface or report to users 2010 as needed.

In light of the description provided here, it will be apparent that by way of example and not by way of limitation, that the innovative technology described here has numerous features and advantages. Among these are:
(1) A system and method having the characteristics described where by forecasting data is captured and/or generated.
(2) Structure, method, and database in which forecast data is organized into category structures and/or hierarchies; and where optionally but advantageously each unit of forecast data can be for one category, for a selected plurality of categories, or for all categories.
(3) Structure, method, and database wherein forecast data is captured at the lowest level of detail or granularity in each category or hierarchy to promote broader ranges of aggregation.
(4) Structure, method, and database wherein forecast data is manifested into a “Variance” value, a “As of When” value and an “As of Now” or “Current” value.
(5) Structure, method, and database wherein forecast data is conducive to asking questions such as “what is the value now?”, “what was the value then (where then is any time in past)?” and “how much did the value changed between time point 1 and time point 2? Where time point 2 could also be “as of now”. And, obtaining meaningful answers to these questions.
(6) Structure, method, and database in which data is aggregated to all levels of all dimensions, categories, and/or hierarchies using conventional analytics and aggregations (OLAP) tools. In this way at least non-limiting examples of the innovative technology is backward compatible with at least some existing analytic machines and engines.
(7) Structure, method, and database in which data is displayed in client as a timeline or trend over time showing the subsequent or chained “As of when” values for a given forecast for a given time period or range.
(8) Structure, method, and database in which change data, delta data, and/or variance data, can be filtered by any relevant dimension, category or hierarchy or combination of multiple.
(9) Structure, method, and database in which volume data is aggregated in order to show “volume of change”, where this may be the total number of changes at a given “as of when” time.
(10) Structure, method, database, and interface wherein graphically, volume data is layered visually in conjunction with “as of when” trending information so a user or analyst can quickly see the forecast value at a particular “as of when” point as well as, the number of changes made on that “as of when” time point.
(11) Structure, method, and database wherein range selection is allowed and facilitated so that users may focus in on portions of the “as of when” trend line and do subsequent analysis of the range.
(12) Structure, method, and database wherein filtering of change trend is done by selecting dimension, category, and/or hierarchy items or multiples. In other words, show trend line for only this thing or these things or this category of things.
(13) Structure, method, and database wherein transactional of atomic change data is also made available so users can analyze the details behind the volume information for a particular “as of when” point or group of points.
(14) Structure, method, and database wherein root cause of variance is provided in a tangible data structure and visual interface so that for a set of trend points, it can be understood what the driving factors are as it relates to the dimensions, categories or hierarchies in effect for the given forecast data being analyzed.
(15) Structure, method, and database wherein change data is further sliced, viewed, and/or analyzed into reason constructs so it can be understood what was the driving force behind the change that was made. Examples would be “Price Pressure, Deal Lost, New Product Added”.

It will thus be seen that the features and aspects set forth above, among those made apparent from the preceding description, are provided and, since changes may be made in carrying out the above system and method and in the construction set forth without departing from the spirit and scope of the invention, it is intended that any and all matter contained in the above description and shown in the accompanying drawings shall be interpreted as illustrative and not in a limiting sense.

We claim:

1. A system for generating a variance based forecast, the system comprising:
(a) multi-dimensional mode processing engine;
(b) a relational database and database structure defined therein for storing forecast updates and metadata that describes dimensions and other configuration information coupled to the processing engine;
(c) a data access layer server for processing requests to both the multi-dimensional mode processing engine and to the relational database system; and
(d) a handler that exposes services for retrieving data from and, in the case of the relational database system, inserting data into the database;
(e) wherein the database stores future event forecast variance data including forecast data pertaining to dates, as-of-when (AOW), and as-of-now (AON) parameters.

2. A computer implemented method for generating a variance based forecast, the method comprising:
(a) operating a multi-dimensional mode processing engine;
(b) establishing a relational database and database structure defined therein for storing forecast updates and metadata that describes dimensions and other configuration information coupled to the processing engine;
(c) processing requests at a data access layer server to both the multi-dimensional mode processing engine and to the relational database system; and
(d) exposing services for retrieving data from and, in the case of the relational database system, inserting data into the database; and
(e) wherein the database stores future event forecast variance data including forecast data pertaining to dates, as-of-when (AOW), and as-of-now (AON) parameters.

3. A computer program product stored on a tangible computer readable media and including executable computer program instructions that when executed in a processing logic and coupled memory, implement a method for generating a variance based forecast, the method comprising:
(a) operating a multi-dimensional mode processing engine;
(b) establishing a relational database and database structure defined therein for storing forecast updates and metadata that describes dimensions and other configuration information coupled to the processing engine;
(c) processing requests at a data access layer server to both the multi-dimensional mode processing engine and to the relational database system; and
(d) exposing services for retrieving data from and, in the case of the relational database system, inserting data into the database;
(e) wherein the database stores future event forecast variance data including forecast data pertaining to dates, as-of-when (AOW), and as-of-now (AON) parameters.

4. A variance engine comprising:
a variance processor configured for processing data elements accessed from an external database defining a data structure and organized according to:
(i) dimensions and hierarchies that categorize forecast data for highly granular variance analysis, and
(ii) forecast information including time based forecast information defined by an as-of-when (AOW) value parameter and an as-of-now (AON) value parameter;
the AON and AOW parameter values being stored and maintained separately for efficient retrieval from the database system; and
the variance processor generating a forecast variance as a difference between a new AON and a last AOW forecast value parameters.

5. The variance engine as in claim 4, further comprising the external database.

6. The variance engine as in claim 4, wherein the forecast variance is generated in real-time on the fly as needed to satisfy a user forecast generation request.

7. A computer implemented method for operating a variance engine, the method comprising:
processing data elements accessed from an external database defining a data structure and organized according to:
(i) dimensions and hierarchies that categorize forecast data for highly granular variance analysis, and
(ii) forecast information including time based forecast information defined by an as-of-when (AOW) value parameter and an as-of-now (AON) value parameter;
storing and maintaining the AON and AOW parameter values separately for efficient retrieval from the database system; and
generating a forecast variance as a difference between a new AON and a last AOW forecast value parameters.

8. The method as in claim 8, further comprising the external database.

9. The method as in claim 9, wherein the forecast variance is generated in real-time on the fly as needed to satisfy a user forecast generation request.

10. A computer program product stored on a tangible computer readable media and including executable computer program instructions that when executed in a processing logic and coupled memory, implement a method for operating a variance engine, the method comprising:
processing data elements accessed from an external database defining a data structure and organized according to:
(i) dimensions and hierarchies that categorize forecast data for highly granular variance analysis, and
(ii) forecast information including time based forecast information defined by an as-of-when (AOW) value parameter and an as-of-now (AON) value parameter;
storing and maintaining the AON and AOW parameter values separately for efficient retrieval from the database system; and
generating a forecast variance as a difference between a new AON and a last AOW forecast value parameters.

11. The computer program product as in claim 10, further comprising the external database.

12. The computer program product as in claim 10, wherein the forecast variance is generated in real-time on the fly as needed to satisfy a user forecast generation request.

13. The method as in claim 7, wherein: forecast data is organized into category structures or hierarchies, and each unit of forecast data can be for category or for a plurality of categories or for all categories.

14. The method as in claim 7, wherein: forecast data is captured at the lowest level of detail in each category or hierarchy to promote broader ranges of aggregation.

15. The method as in claim 7, wherein: forecast data is manifested into a “variance” value, a “as of when” value, and an “as of now” or “current” value.

16. The method as in claim 7, wherein: forecast data is conducive to asking questions including (i) what is the value now?, (ii) what was the value then (where then is any time in past)?, and (iii) how much did the value change between time point t=t1 and time point t=t2? Where time point t=t2 could also be as of now.

17. The method as in claim 7, wherein: data is aggregated to all levels of all dimensions, categories and/or hierarchies using analytics and aggregations tools.

18. The method as in claim 7, wherein: data is displayed in a client as a timeline or trend over time showing the subsequent or chained “As of when” values for a given forecast for a given time period or range.

19. The method as in claim 7, wherein: change data is selectively filtered by any relevant dimension, category or hierarchy or combination of multiple dimensions, categories, or hierarchies.

20. The method as in claim 7, wherein: volume data is aggregated in order to show volume of change as a total number of changes at a given as of when time.

21. The method as in claim 7, wherein: volume data is generated and graphically layered visually in conjunction with “as of when” trending information so a user can quickly see the forecast value at a particular “as of when” point as well as, the number of changes made on that “as of when” time point.

22. The method as in claim 7, wherein: range selection is allowed so that users may focus in on portions of the “as of when” trend line and do subsequent analysis of the range.

23. The method as in claim 7, wherein: filtering of change trend is done by selecting dimension, category or hierarchy items or multiple.

24. The method as in claim 7, wherein: transactions of atomic change data is also made available so users can analyze the details behind the volume information for a particular “as of when” point or group of points.

25. The method as in claim 7, wherein: root cause of variance is provided in a visual interface so that for a set of trend points, it can be understood what the driving factors are as it relates to the dimensions, categories or hierarchies in effect for the given forecast data being analyzed

26. The method as in claim 7, wherein: change data is further sliced or analyzed and presented for viewing into reason constructs so it can be understood what was the driving force behind the change that was made. Examples would be “Price Pressure, Deal Lost, New Product Added”.

27. A computer implemented method for obtaining a variance based forecast, the method comprising:
establishing an electronic connection with a server computer configured operate a multi-dimensional mode processing engine that is coupled to a relational database and database structure defined therein for storing forecast updates and metadata that describes dimensions and other configuration information including future event forecast variance data including forecast data pertaining to dates, as-of-when (AOW) forecast parameters, and as-of-now (AON) forecast parameters;
sending a request for a forecast to the server, wherein the request is structured to be received at the server computer at a data access layer server to both the multi-dimensional mode processing engine and to the relational database system; and
the request identifying a forecast parameters including forecast data pertaining to dates, as-of-when (AOW), and as-of-now (AON) parameters and further structured to retrieve data from and, in the case of the relational database system, insert data into the relational database.

28. The computer implemented method for obtaining a variance based forecast as in claim 27, the method further comprising:
establishing the relational database and database structure defined therein for storing forecast updates and metadata that describes dimensions and other configuration information coupled; and
configuring and operating the multi-dimensional mode processing engine coupled with the relational database and database structure.
